(19) United States
(12) Patent Application Publication
(10) Pub. No.: US 2019/0101411 A1
(43) Pub. Date: Apr. 4, 2019

(54) RESOURCE METER SYSTEM AND METHOD

(71) Applicant: Pacific Gas and Electric Company, San Francisco, CA (US)

(72) Inventors: Earle S. Davis, Walnut Creek, CA (US); Young D. Nguyen, Alameda, CA (US); Alan S. Jones, Berkeley, CA (US); Shelley R. Williams, Antioch, CA (US); Alexander P. Yan, Berkeley, CA (US); James Adams, San Francisco, CA (US); Darren Cain, San Francisco, CA (US); Edmond Padrones, Benicia, CA (US); Quoc Hoang, Walnut Creek, CA (US); Fela O. Odeyemi, Walnut Creek, CA (US); Maz Y. Bijan, Fremont, CA (US)

(21) Appl. No.: 16/143,295

(22) Filed: Sep. 26, 2018

Related U.S. Application Data
(63) Continuation-in-part of application No. 15/784,711, filed on Oct. 16, 2017.
Application No. 15/784,711 is a continuation-in-part of application No. 15/872,771, filed on Jan. 16, 2018.
(60) Provisional application No. 62/563,470, filed on Sep. 26, 2017.
(60) Provisional application No. 62/617,949, filed on Jan. 16, 2018.

(51) Int. Cl. G01D 4/00; H02J 7/00; G01F 15/06

(52) U.S. Cl. CPC G01D 4/004; G01F 15/063; H02J 7/0052

(57) ABSTRACT

Embodiments of the invention include a resource metering system and method including one or more sensors, and an automatic shut-off valve, a power source, a capacitor-based charging circuit, an RF communications board, and a processor capable of executing instructions from a non-transitory computer-readable storage medium of a resource distribution system. The operation of the processor by the instructions can enable the resource metering system to wirelessly receive and act on signals or data transmitted from the RF communication board, where the signals or data are received from the sensors.

### RELATED APPLICATIONS

This application is a continuation-in-part of U.S. patent application Ser. No. 15/784,711, filed on Oct. 16, 2017, and U.S. patent application Ser. No. 15/872,771, filed Jan. 16, 2018, which claims the benefit and priority to U.S. Provisional Application No. 62/563,470, filed on Sep. 26, 2017, and U.S. Provisional Application No. 62/617,949, filed Jan. 16, 2018, the entire contents of which are incorporated herein by reference.

### BACKGROUND

Many of today's energy metering systems such as residential and commercial electric and gas meters are bulky and not conveniently mounted or integrated with new or existing infrastructure. Conventional diaphragm meters (e.g., such as gas and some electric meters) include many moving parts such as chambers, gears, flag arm assemblies, valves, and other components that necessitate a relatively bulky housing, periodic maintenance, and/or have an undesirable life-span. Further, most current conventional meters are not remotely readable, and don't offer any other functionality beyond usage metering. Moreover, mounting pedestals for self-contained meters are also bulky and costly, and are generally difficult to integrate with adjoining systems.

With the accelerating growth of distributed energy systems and mobile transportation and infrastructure, it would be desirable to provide energy metering systems that can be easily and unobtrusively integrated with existing infrastructure to provide convenient energy delivery, and real time consumption monitoring and transactions. Furthermore, many residential and small commercial customers would benefit from advanced design solid-state meters housing in a smaller footprint that provide various convenience, customization, and safety features such as wireless communication and access, pressure monitoring, seismic detection, automatic methane detection (e.g., for in-house and on-site gas leak detection, electrical malfunction or shorting), automatic safety shut-off valves, remote/turn-on capability, anti-tamper alarms, pre-payment functionalities, and multi-dwelling design with master/slave communications.

### SUMMARY

Some embodiments comprise a resource metering system comprising at least one resource meter including one or more sensors, and at least one automatic shut-off valve, at least one coupled power source, a capacitor-based charging circuit, and at least one RF communications board. Some embodiments include at least one processor executing instructions from a non-transitory computer-readable storage medium of a resource distribution system to cause the at least one processor to wirelessly receive and act on one or more signals or data transmitted from the at least one RF communication board, where the one or more signals or data are received from the one or more sensors.

In some embodiments, the at least one resource meter includes at least one integrated or coupled metrology board. In some further embodiments, the at least one resource meter includes at least one coupled AC power supply coupled to the capacitor-based charging circuit. In some embodiments, the at least one resource meter includes at least one battery coupled to the capacitor-based charging circuit.

In some further embodiments, the at least one coupled power source comprises a capacitor of the capacitor-based charging circuit. In some embodiments, the one or more sensors comprise at a flow sensor and/or a pressure sensor. In some embodiments, the at least one sensor comprises a resource sensor and/or a temperature sensor. In some embodiments, the at least one sensor comprises a seismic sensor.

In some other embodiments of the invention, the capacitor-based charging circuit comprises an output circuit including a chargeable capacitor coupled to a plurality of switches, wherein the state of the switches controls charging or discharging of the capacitor.

In some embodiments, the instructions are configured to cause a processor to operate the automatic shut-off valve based at least in part on a state or operation of the one or more sensors. In some further embodiments, the at least one coupled power source comprises a source of gas.

Some embodiments of the invention include a computer-implemented method of metering a resource comprising at least one processor executing instructions from a non-transitory computer-readable storage medium of a resource distribution system, where the instructions are configured to cause a processor to wirelessly receive and act on one or more signals or data from one or more sensors of a resource delivery system, and to monitor and track resource usage and/or operations of the at least one resource meter. In some embodiments, the resource delivery system of the computer-implemented method comprises at least one resource meter including the one or more sensors, and at least one automatic shut-off valve, a coupled power source, capacitor-based charging circuit, and at least one RF communications board.

Some further embodiments of the computer-implemented method include at least one resource meter that includes at least one integrated or coupled metrology board. Some embodiments of the computer-implemented method include at least one resource meter that includes at least one coupled AC power supply coupled to the capacitor-based charging circuit. Some embodiments of the computer-implemented method include at least one resource meter that includes at least one battery coupled to the capacitor-based charging circuit.

In some embodiments of the computer-implemented method, the one or more sensors comprise at least one of a flow sensor and a pressure sensor. Some embodiments of the computer-implemented method include the one or more sensors that comprise a resource sensor and/or a temperature sensor.

Some other embodiments of the computer-implemented method include the one or more sensors that comprise a seismic sensor. Some further embodiments of the computer-implemented method include instructions that are configured to cause a processor to operate the automatic shut-off valve based at least in part on a state or operation of the one or more sensors.

### DESCRIPTION OF THE DRAWINGS

FIG. 1A illustrates an assembly including a solid-state resource meter coupled to a gas conduit in accordance with some embodiments of the invention.

FIG. 1B illustrates a solid-state resource meter in accordance with some embodiments of the invention.

FIG. 1C illustrates an assembly view of a solid-state resource meter in accordance with some embodiments of the invention.

FIG. 2A illustrates an earth-quake sensor safety technology for solid-state resource meters in accordance with some embodiments of the invention.

FIG. 2B illustrates a pressure sensor safety technology for solid-state resource meters in accordance with some embodiments of the invention.

FIG. 2C illustrates a thermocouple safety technology for solid-state resource meters in accordance with some embodiments of the invention.

FIG. 2D illustrates an automatic shut-off valve safety technology for solid-state resource meters in accordance with some embodiments of the invention.

FIG. 2E illustrates a methane leakage sensor safety technology for solid-state resource meters in accordance with some embodiments of the invention.

FIG. 3A illustrates a communication board for solid-state resource meters in accordance with some embodiments of the invention.

FIG. 3B illustrates a metrology board communication for solid-state resource meters in accordance with some embodiments of the invention.

FIG. 4A depicts a non-limiting option for powering a solid-state resource meter assembly in accordance with some embodiments of the invention.

FIG. 4B shows a solid-state resource meter layout architecture in accordance with some embodiments of the invention.

FIG. 4C shows pressure-sensor assembly of the solid-state resource meter layout architecture of FIG. 4B in accordance with some embodiments of the invention.

FIG. 4D shows a non-limiting embodiment of a sensor of the solid-state resource meter layout architecture of FIG. 4B in accordance with some embodiments of the invention.

FIG. 4E shows a non-limiting embodiment of a MEMS sensor of the solid-state resource meter layout architecture of FIG. 4B in accordance with some embodiments of the invention.

FIG. 5A shows a non-limiting example of a power charge operation circuitry in accordance with some embodiments of the invention.

FIG. 5B shows a non-limiting examples of power storage operation circuitry in accordance with some embodiments of the invention.

FIG. 5C shows a non-limiting examples of power discharge operation circuitry in accordance with some embodiments of the invention.

FIG. 6A and 6B show conventional meters.

FIG. 7A shows a front view of an electric meter assembly in accordance with some embodiments of the invention.

FIG. 7B shows a perspective view of an electric meter core base in accordance with some embodiments of the invention.

FIGS. 7C-7D illustrate side views of the electric meter core base of FIG. 7B in accordance with some embodiments of the invention.

FIG. 8 illustrates an assembly view with a front side view of an electric meter and utility or light pole in accordance with some embodiments of the invention.

FIG. 9 illustrates an assembly view of an electric meter in accordance with some embodiments of the invention.

FIG. 10 shows a non-limiting embodiment of a board architecture of the electric meter of FIG. 9 in accordance with some embodiments of the invention.

FIG. 11A shows a perspective view of an electric meter module in accordance with some embodiments of the invention.

FIG. 11B shows a top view of the electric meter module of FIG. 11A in accordance with some embodiments of the invention.

FIGS. 11C-11D show end view of the electric meter module of FIG. 11A in accordance with some embodiments of the invention.

FIG. 11E shows a cross-sectional view of the electric meter module of FIG. 11A in accordance with some embodiments of the invention.

FIG. 12 is a perspective view of a conventional meter room.

FIG. 13 is perspective view of a meter room of the future in accordance with some embodiments of the invention.

FIG. 14 is perspective view of a meter room in accordance with some further embodiments of the invention.

FIG. 15 is perspective view of a meter system with a front cover removed or absent in accordance with some further embodiments of the invention.

FIG. 16 is a close-up perspective view of a meter system in accordance with some further embodiments of the invention.

FIG. 17 is a close-up perspective view of a meter of the meter system of FIG. 15 in accordance with some further embodiments of the invention.

FIG. 18A illustrates a transformer-rated meter socket assembly in accordance with some embodiments of the invention.

FIG. 18B illustrates a partially transparent transformer-rated plunger switch in accordance with some embodiments of the invention.

FIG. 19A illustrates an assembly of a multi-node wireless system with coupled electric meter in accordance with some embodiments of the invention.

FIG. 19B shows a close-up view of the assembly of FIG. 19A mounted to a pole in accordance with some embodiments of the invention.

FIG. 19C shows a view of the assembly of FIG. 19A mounted to a pole in accordance with some embodiments of the invention.

FIG. 20A shows a conventional electric vehicle panel in accordance with some embodiments of the invention.

FIG. 20B shows a non-limiting embodiment of the electric vehicle panel in accordance with some embodiments of the invention.

FIG. 21A illustrates a bottom perspective view of smart pole meter in accordance with some embodiments of the invention.

FIG. 21B illustrates a side perspective view of smart pole meter in accordance with some embodiments of the invention.

FIG. 22A illustrates a conventional electric vehicle charging station with mounted electric meter in accordance with some embodiments of the invention.

FIG. 22B illustrates an electric meter in accordance with some embodiments of the invention.

FIG. 22C illustrates a non-limiting embodiment of an electric vehicle charging station with representation of an integrated electric meter in accordance with some embodiments of the invention.

FIG. 23 shows a non-limiting embodiment of a system architecture in accordance with some embodiments of the invention.

FIG. 24 shows a non-limiting embodiment of a system architecture in accordance with some embodiments of the invention.

FIG. 25 illustrates a metering operational Assessment Tester (MOAT) graphical diagram in accordance with some embodiments of the invention.

FIG. 26 illustrates a voltage selection module in accordance with some embodiments of the invention.

FIG. 27 illustrates a circuit board layout in accordance with some embodiments of the invention.

FIG. 28 illustrates a wiring diagram in accordance with some embodiments of the invention.

FIG. 29 illustrates a circuit board layout in accordance with some embodiments of the invention.

FIG. 30 illustrates a wiring diagram in accordance with some embodiments of the invention.

FIG. 31 illustrates a circuit board layout in accordance with some embodiments of the invention.

FIG. 32 illustrates a wiring diagram in accordance with some embodiments of the invention.

FIG. 33 illustrates a circuit board layout in accordance with some embodiments of the invention.

FIG. 34 illustrates a smart pole architecture in accordance with some embodiments of the invention.

FIGS. 35A-35B illustrate layouts of smart pole heads in accordance with some embodiments of the invention.

FIG. 36 illustrates a computing system suitable for managing and operating the processing, communication, and data transfer protocols of a resource delivery and metering system and method in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Some embodiments of the invention include components, systems, and methods to sense, and/or measure, and/or deliver or transfer a resource such as electricity, natural gas, or other fuel. As used herein, some embodiments include resource meters for gas metering and delivery, and where “resource meter” is referenced or described, the resource meter can be a gas meter. Some further embodiments include resource meters for electricity metering and delivery, and where resource meter is referenced or described, the resource meter is an electric meter. In some embodiments, one or more of the features, operating functions, components, or assemblies as described for resource meters that are gas meters can be applied to and/or be used with resource meters that are electric meters, and vice versa.

In some embodiments, the components, systems, and methods described herein can deliver not only data and information for billing, but also data for critical gas and electric situations. For gas, data may include, but not limited to, temperature for local fire safety, pressure for compliance and safety, flow and leak for safety, and remote shut-off capability. For electric, data may include, but not limited to temperature for wildfire safety, voltage for wire-down safety and outage restoration, and remote shut-off capability

Some embodiments of the invention include components, systems, and methods to sense, and/or measure, and/or deliver or transfer naturally occurring and/or synthetic fuels such as hydrocarbon gas mixtures that comprise methane. However, the components, systems, and methods disclosed herein are not necessarily limited to methane containing gas or related gas or fluids. In some embodiments, the components, systems, and methods disclosed can be configured to sense, and/or measure, and/or deliver or transfer other gases or fluids. As disclosed herein, natural gas can consist primarily of methane, but may include small portions of other higher alkanes. Further, nitrogen, carbon dioxide, nitrogen, helium, and/or hydrogen sulfide may be present in small quantities.

Some embodiments of the invention include solid-state resource meters comprising a size or volume footprint that is smaller than conventional solid-state resource meters. Some embodiments of the invention include one or more convenience features, one or more customization features, and/or one or more safety features. For example, some embodiments of the invention include wireless communication and access capability. Some further embodiments include systems and methods for pressure monitoring. Some further embodiments of the invention include systems and methods for seismic detection. Some other embodiments include automatic methane detection (e.g., for in-house and on-site gas leak detection).

Some embodiments of the invention include automatic safety shut-off valves. Some further embodiments include remote/turn-on capability. Some embodiments of the invention include anti-tamper alarms. Some other embodiments of the invention include pre-payment functionalities. Some embodiments of the invention include a multi-dwelling design with master/slave communications.

In some embodiments of the invention, any of the meters or assemblies comprising meters and/or any of the systems and methods disclosed herein may include improved meter accuracy and operational efficiencies. Some embodiments include a resource delivery and metering system that can comprise a modular metering design for ease of field installation, maintenance, and operations. Some embodiments of the invention include a fixed, semi-permanent, and/or mobile resource meter, enabling customers and utilities to monitor and track resource usage and/or operations of customer appliance, and/or devices, and/or vehicles (including electric vehicles), and/or utility infrastructure operations in real-time and by location.

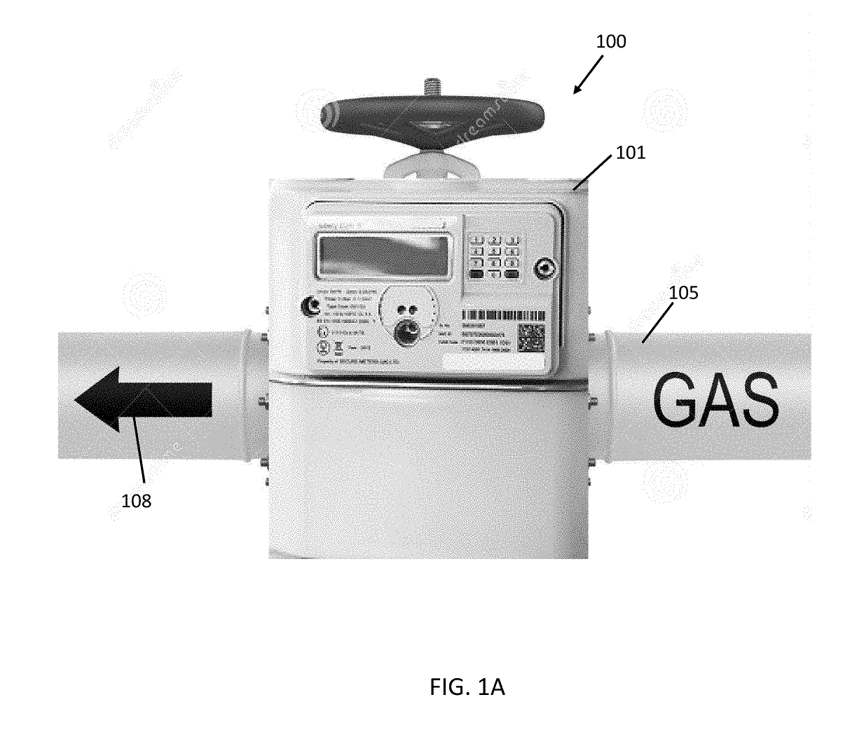

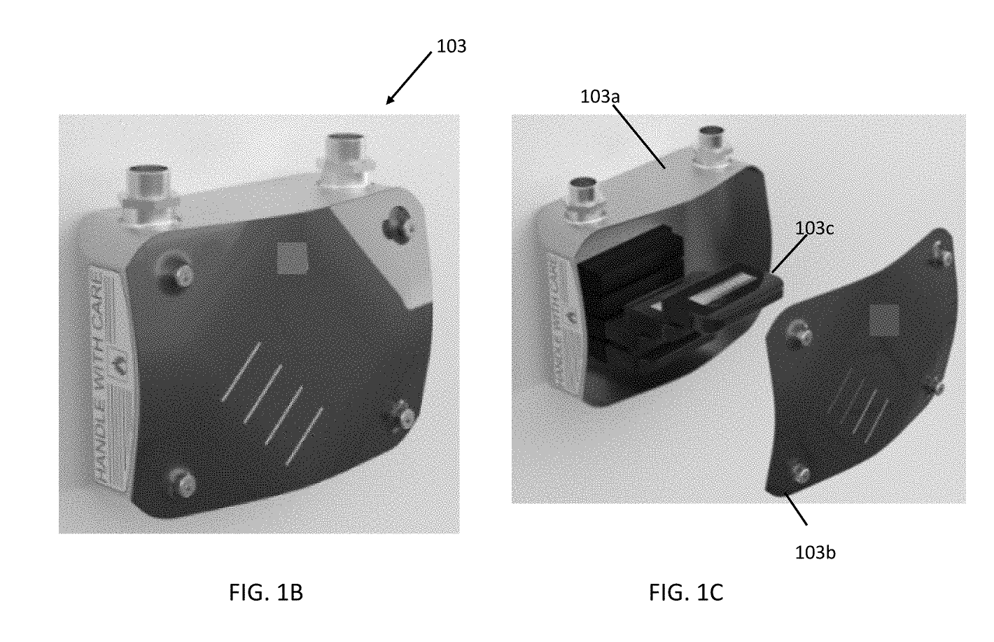

Referring to FIG. 1A, illustrating an assembly 100 including a solid-state resource meter 101 coupled to a gas conduit 105, in some embodiments, the meter 101 can be integrated or coupled to the gas conduit 105. In some embodiments, the meter 101 can form part of at least a portion of the gas conduit 105. In some embodiments, one or more portions of the gas conduit 105 can be coupled to an inlet of the meter 101 (e.g., on one side of the meter 101). In some embodiments, a portion of the gas conduit 105 can be coupled to an outlet of the meter 101 (e.g., on one side of the meter 101).

In some embodiments of the invention, the solid-state resource meter 101 (also termed interchangeably herein as “G-NGM”) can comprise one or more components, systems, and methods to sense, and/or measure, and/or store, and/or transmit information related to any resource entering and/or exiting the meter 101 (e.g., where arrow 108 shows the direction of resource flow).

In some embodiments of the invention, the meter 101 can include one or more ultrasonic and/or MEMS metering or sensing technologies that can include or utilize one or more ultrasonic-based total flow measurement sensors or monitors. In some embodiments of the invention, the ultrasonic and/or MEMS technology of the meter 101 can provide one or more of pressure sensing capabilities, and/or temperature sensing capabilities, and/or flow rate sensing capabilities, and/or resource usage sensing capabilities, and/or remote meter reading capabilities, and/or automatic meter management capabilities, and/or remote or automatic valve shut-off capabilities.

Some embodiments include one or more stand-alone meters 101 assembled and/or configured as part of a resource delivery or transfer system. Other embodiments include one or more coupled and/or networked meters 101 forming part of and/or coupled to a resource delivery system. Some embodiments include a plurality of networked meters 101 that can comprise a resource delivery and metering system. In some embodiments, one or more coupled and/or networked meters 101 can form part of a “resource smart grid” (e.g., such as an electricity smart grid or a gas smart grid devices that provide data for critical situations, such as electric voltage, seismic, temperature data and gas temperature, pressure, and flow/leak data.) In some embodiments of the invention, the resource delivery and metering system can include one or more of solid-state resource meter hardware, meter firmware, meter software, and a head-end operations software application.

In reference to FIGS. 1B and 1C, some embodiments include one or more stand-alone meters 103 assembled and/or configured as part of a resource delivery or transfer system. Other embodiments include one or more coupled and/or networked meters 103 forming part of and/or coupled to a resource delivery system. Some embodiments include a plurality of networked meters 103 that can comprise a resource delivery and metering system. In some embodiments, one or more coupled and/or networked meters 103 can form part of a “gas smart grid”. In some embodiments of the invention, the resource delivery and metering system can include one or more of solid-state resource meter hardware, meter firmware, meter software, and a head-end operations software application. As shown in the assembly view of FIG. 1C, in some embodiments, meter 103 can comprise a housing 103a and removable cover 103b enclosing one or more removable and/or modular components 103c. In some embodiments, the meter 103 can be any of the meters disclosed herein and/or can form part of any of the resource delivery and metering systems disclosed herein.

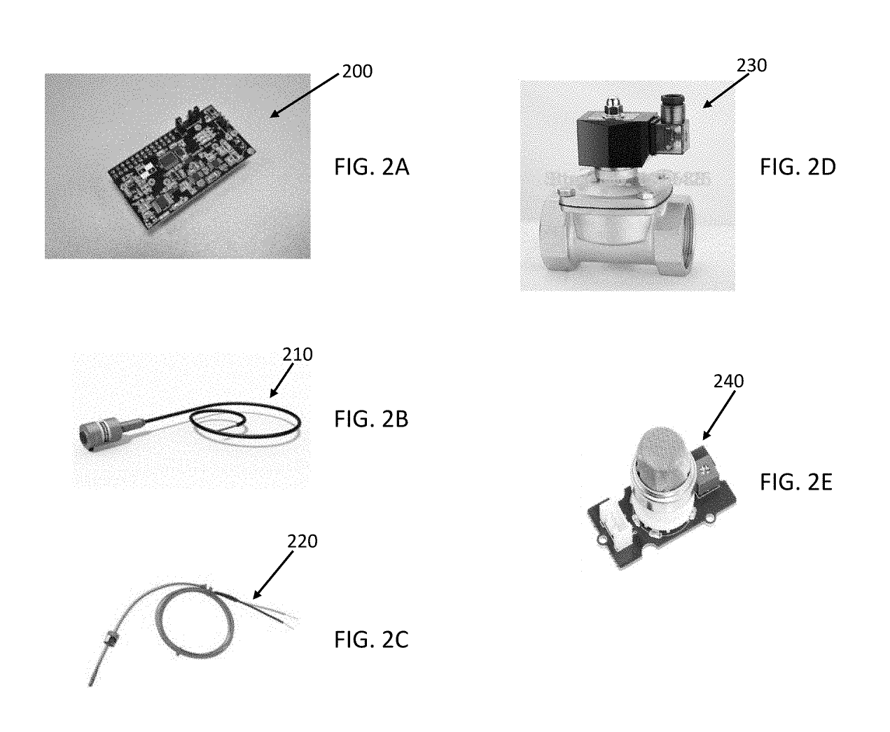

Some embodiments of the invention include a resource delivery and metering system that can collect and display information related to hourly resource usage and interval, resource pressure, and resource temperature. In some embodiments, the system can remotely monitor and/or report on resource pressure readings and leaks at the meter locations. Some embodiments include various safety sensors, detectors and associated safety and actuation circuitry. For example, some embodiments include various safety sensors. For example, FIGS. 2A-2E illustrate non-limiting options for inclusion of safety technologies for solid-state resource meters in accordance with some embodiments of the invention. For example, FIG. 2A illustrates an earth-quake sensor safety technology for solid-state resource meters in accordance with some embodiments of the invention. Further, FIG. 2B illustrates a pressure sensor safety technology for solid-state resource meters in accordance with some embodiments of the invention. Further, FIG. 2C illustrates a thermocouple safety technology for solid-state resource meters in accordance with some embodiments of the invention. Further, FIG. 2D illustrates an automatic shut-off valve safety technology for solid-state resource meters in accordance with some embodiments of the invention. Further, FIG. 2E illustrates a methane leakage sensor safety technology for solid-state resource meters in accordance with some embodiments of the invention. Some embodiments include methane detection, pipeline meter and/or safety device, and “TOU (time of use) billing” functionality for gas customers.

In reference to FIG. 2A, in some embodiments, the meter 101 can include one or more seismic or earth-quake sensors (seismic detector 200) configured to detect an earthquake and/or other seismic activity (e.g., after-shocks and other tremors). In some embodiments, the seismic detector 200 can be coupled to a network for relaying seismic information. In some embodiments, the meter 101 can shut off if seismic activity reaches certain thresholds, and may provide the ability to automatically turn back on if certain conditions are met.

FIG. 2B illustrates a pressure sensor 210 safety technology for solid-state resource meters such as meter 101 in accordance with some embodiments of the invention. In some embodiments, the pressure sensor 210 can be used to measure a pressure of a resource such as gas entering the meter 101.

FIG. 2C illustrates a thermocouple 220 safety technology for solid-state resource meters such as meter 101 in accordance with some embodiments of the invention. In some embodiments, the thermocouple 220 can be used to measure a temperature of a resource such as gas entering the meter 101.

FIG. 2D illustrates an automatic shut-off valve 230 safety technology for solid-state resource meters such as in accordance with some embodiments of the invention. In some embodiments, the valve 230 can close automatically or be manually activated. In some embodiments, the valve 230 can be opened or closed to control the flow of a resource such as gas through the meter 101.

FIG. 2E illustrates a methane leakage sensor 240 safety technology for solid-state resource meters such as meter 101 in accordance with some embodiments of the invention. In some embodiments, the methane leakage sensor 240 can be configured for leak discovery and monitoring. In some embodiments, diagnostic circuitry can detect leaks based on resource flow and usage patterns.

In some embodiments, the automated shut-off valve 230 can be coupled to any of the safety technologies disclosed or other convention safety technologies. For example, in some embodiments of the invention, the seismic detector 200 can be coupled to an automated shut-off valve 230 that can be activated upon the detection of certain seismic activity. In other embodiments, the pressure sensor 210 can be coupled to an automated shut-off valve 230 that can be activated upon the detection of a specific pressure or pressure range.

In some embodiments, the thermocouple 220 can be coupled to an automated shut-off valve 230 that can be activated upon the detection of a certain temperature or temperature range. In some embodiments, the automated shut-off valve 230 can be coupled to a methane leakage sensor 240 where the automated shut-off valve 230 can be closed based on a detection of methane gas. In some embodiments, when the automated shut-off valve 230, the meter 101 can report a shut-off event.

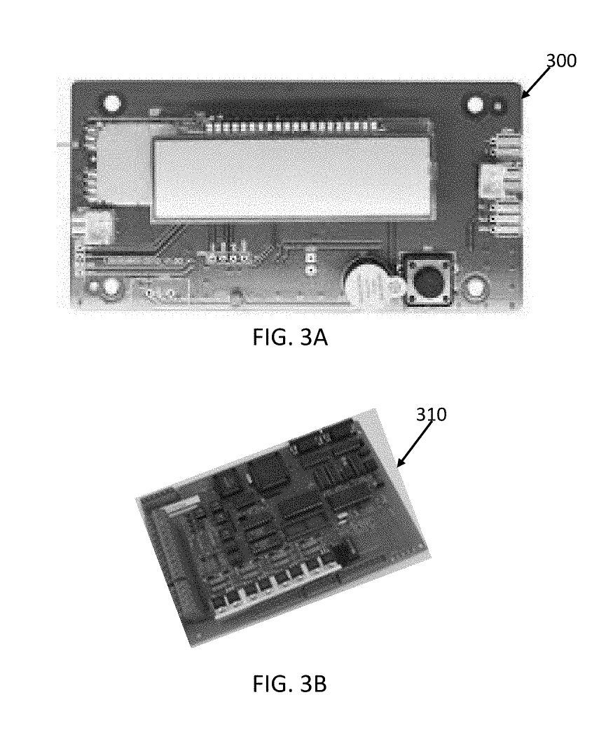

FIG. 3 illustrates non-limiting options for inclusion of communication technologies for solid-state resource meters in accordance with some embodiments of the invention. In some embodiments, the meter 101 can include a communication board 300 and/or a metrology board 310. As described earlier, in some embodiments, the meter 101 can include a seismic detector 200 can be coupled to a network for relaying seismic information. In some embodiments, the communication board 300 and/or a metrology board 310 coupled to an external network for communication information such as information from the seismic detector 200. In some further embodiments, the communication board 300 and/or a metrology board 310 can be coupled to one or more other sensors of the meter 101, including, but not limited to the thermocouple 220, and/or the pressure sensor 210, and/or the methane leakage sensor 240. In some embodiments, when the meter 101 can any sensed or monitored parameter from any integrated sensor or monitor, including, any one or more of the sensors of the meter 101, including, but not limited to the thermocouple 220, and/or the pressure sensor 210, and/or the methane leakage sensor 240, and or seismic detector 200.

In some embodiments of the invention, the meter 101 or a resource meter assembly including the meter 101 can comprise one or more RF components. In some embodiments, the RF components can be integrated with or coupled to the communication board 300 and/or a metrology board 310. For example, some embodiments include RF components operating in a 2.4 GHz-ISM frequency band. Some embodiments include an RF system and method of operation compatible with Bluetooth® and IEEE 802.11x within a mobile device, or an IEEE 802.15.4-based specification communication protocols (e.g., ZigBee®) communications interface or protocol. Some embodiments include one or more wireless interfaces to a central system including legacy (e.g., Aclara Technologies, LLC, and Silver Spring Networks, Inc. as non-limiting examples), and/or (LTE/4G capable systems). Some further embodiments include an interface to home appliances for metering and control (e.g., using Bluetooth®, Wi-Fi, Wi-Sun or other home area networking protocols). In some embodiments, the meter 101 can include revenue grade accuracy (+/−1%). In some embodiments, the meter 101 includes a low power metering chip (ASIC). Bluetooth is a registered trademark owned by Bluetooth®SIG.

In some embodiments, the G-NGM (e.g., meter 101) can include a flexible or customizable or programmable communications board that provides RF communication with various capabilities. Some further embodiments include RFID communication capability. Some embodiments include RFID interfaces for communication and/or for asset tracking. In some embodiments of the invention, the G-NGM can be equipped with various communication technologies that can switch between, receive and provide, including but not limited to, cellular 4G/LTE, Wi-Fi, WiMAX, WiSun, 400 MHz RF, 900 MHz RF, etc.

In some embodiments of the invention, the G-NGM can be coupled to a base assembly or component that can include one or more of the aforementioned communication technologies. In some embodiments, the communication board 300 can be integrated with or removable from the G-NGM or base. In some embodiments, the base can be replaceable, interchangeable and/or upgradeable depending on the resource needs and requirements of the customer or the utility company. For example, some embodiments include G-NGM capable of RFID standards for automatic identification and item management (e.g., with ISO 18000 series standards). Some embodiments of the invention include an 18000-1 standard that uses generic parameters for air interfaces for globally accepted frequencies. Some embodiments can use an 18000-2 standard with an air interface for 135 KHz. Some further embodiments can use an 18000-3 standard with an air interface for 13.56 MHz. In some further embodiments of the invention, standard 18000-4 can use an air interface for 2.4 GHz. In other embodiments of the invention, standard 18000-5 with an air interface for 5.8 GHz can be used. In some other embodiments, 18000-6 with an air interface for 860 MHz to 930 MHz can be used. In some alternative embodiments, standard 18000-7 with an air interface at 433.92 MHz can be used.

In some embodiments of the invention, the resource delivery and metering system (e.g., such as meter 101) can calculate and display a load profile of one or more resource consumers (e.g., such as gas customers) using data obtained from one or more G-NGMs (i.e., the meter 101 and one or more other meters 101). In some embodiments, the meter 101 can collect and display information related to a remote valve shut-off in one or more G-NGM's. Some embodiments include multi-dwelling unit capabilities where one or more networked or coupled G-NGM's can serve multiple customers of one or more units of a multi-dwelling unit. In some embodiments, one or more G-NGMs coupled to a network can function as a master controller with other G-NGM's acting as slave controllers and/or meters (e.g., using a master and slave communication method).

In some embodiments, the resource delivery and metering system can collect and transmit interval resource usage or consumption over the air (e.g., wirelessly) to a billing system (e.g., as an automatic meter reading) and/or through a land-line such as a telephone line and/or a fiber optic cable. In some further embodiments, the resource delivery and metering system can sense, measure, and promptly transmit, and store specific resource information. In some embodiments of the invention, the G-NGM can include a data aggregation capacity. In some embodiments, the solid-state resource meter can provide a resource usage and/or consumption record, including, but not limited to, average resource consumption, and/or minimum consumption, and/or peak consumption, and/or a calculated projected consumption etc.

In some embodiments of the invention, the meter 101 can include a time synchronization (including, but not limited to, timers, clocks and date), and resource flow data, including volume and time. Some embodiments include a meter 101 with a data transmission record. For example, some embodiments include a meter 101 with a data transmission record of frequency, and/or signal strength, and/or DCH handshake, and/or an LED that indicates good/bad signal+DCH). In some further embodiments, the meter 101 can provide diagnostic information (e.g., related to normal operation and/or one or more prior or current faults). In some embodiments, the meter 101 can provide a meter location, a service profile identifier (“SPID”), a serial number of the meter 101, and/or a maintenance record.

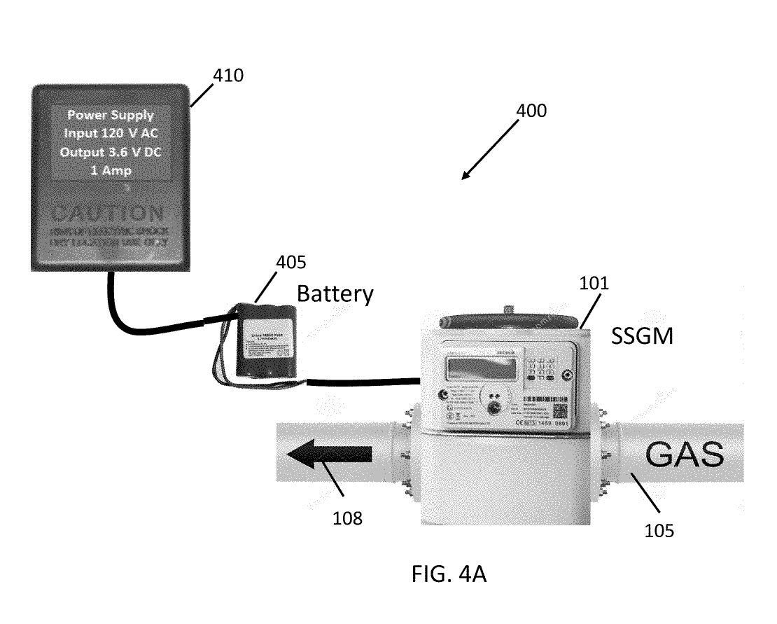

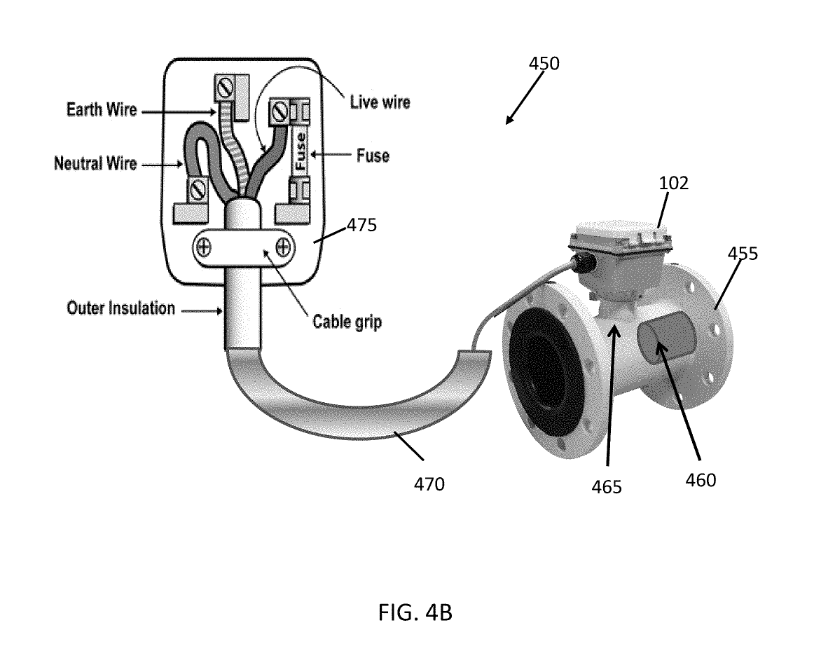

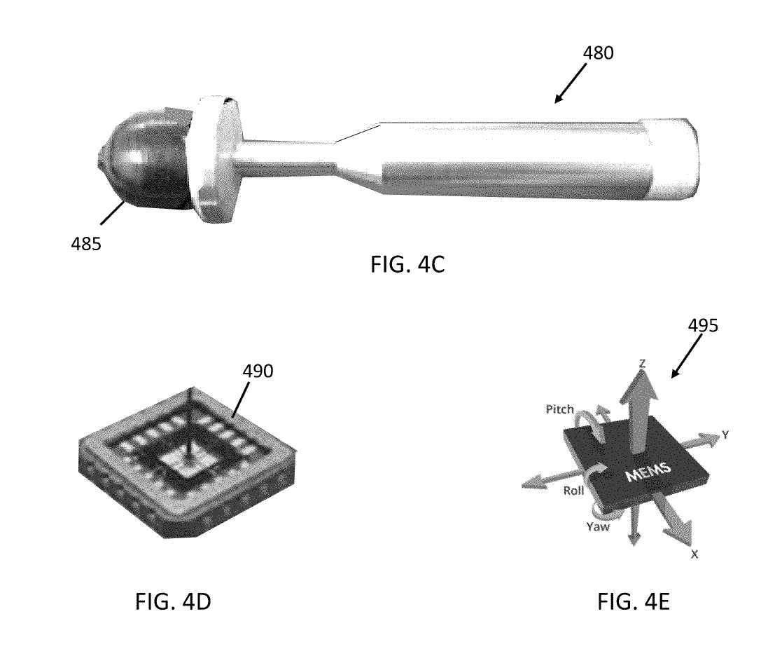

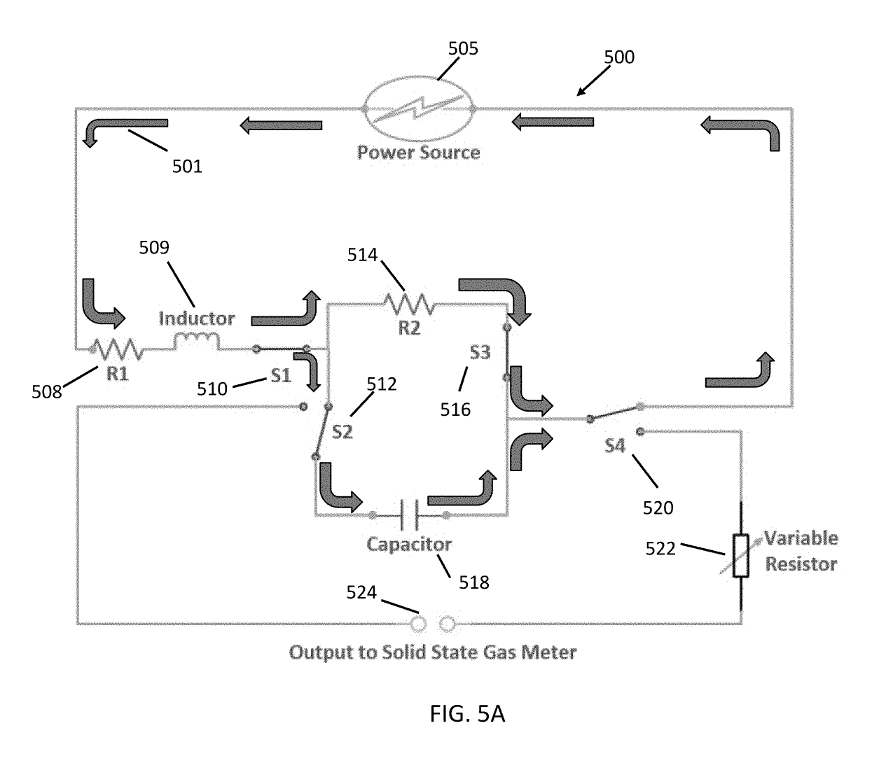

FIG. 4A depicts a non-limiting option for powering a solid-state resource meter assembly 400 in accordance with some embodiments of the invention. In some embodiments of the invention, the meter 101 can be at least partially DC powered. In some other embodiments, the meter 101 can be at least partially AC powered using supply 410. Some embodiments include an autonomous power generation via resource kinetic energy. Some further embodiments include autonomous power storage via capacitors, inductors, and/or auxiliary battery. In some embodiments, DC power can be provided to the solid-state resource meter by an AC power supply 410, a battery 405, or by kinetic resource flow through the meter (flow arrow 108), or a combination thereof.

FIG. 4B shows a solid-state resource meter layout architecture 450 in accordance with some embodiments of the invention. In some embodiments, the meter 102 can be positioned, coupled, or integrated with resource transfer pipe 455. In some embodiments, the meter 102 can comprise the meter 101. In some embodiments, an automatic shut-off valve 460 can be positioned, coupled, or integrated with resource transfer pipe 455. Further, some embodiments include one or more sensors 465 within the meter 102, coupled to the meter 102, and/or positioned, coupled, or integrated with resource transfer pipe 455. In some embodiments, the meter 102 can be coupled to a power cord 470 that is electrically coupled to a plug 475 that can be coupled to a power source.

In some embodiments of the invention, the sensors 465 can comprise one or more of a flow rate sensor, a pressure sensor, and/or a temperature sensor. For example, in reference to FIG. 4C, showing a pressure-sensor assembly 480 of the solid-state resource meter layout architecture 450 of FIG. 4B, in some embodiments, a sensor head 485 of the assembly 480 can house one or more sensors. For example, FIG. 4D shows a non-limiting embodiment of a sensor 490 of the solid-state resource meter layout architecture 450 of FIG. 4B in accordance with some embodiments of the invention. Further, FIG. 4E shows a non-limiting embodiment of a MEMS sensor 495 of the solid-state resource meter layout architecture 450 of FIG. 4B in accordance with some embodiments of the invention. In some embodiments, the sensor 495 can comprise a seismic or earth-quake sensor (e.g., seismic detector 200) configured to detect an earthquake and/or other seismic activity (e.g., after-shocks and other tremors). Other embodiments can include any conventional sensor and/or sensor housing.

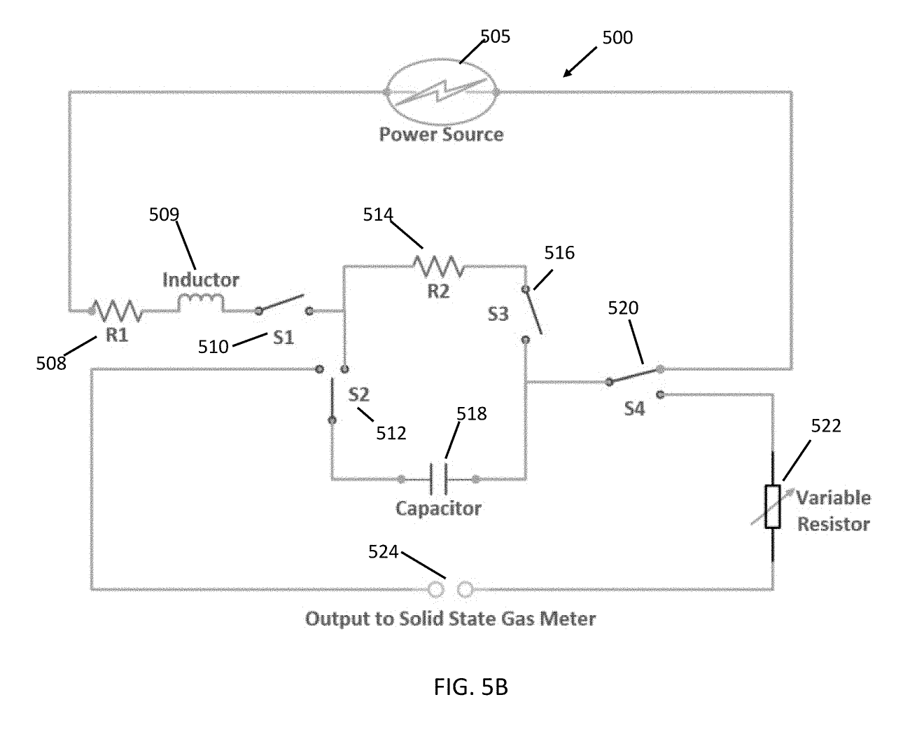

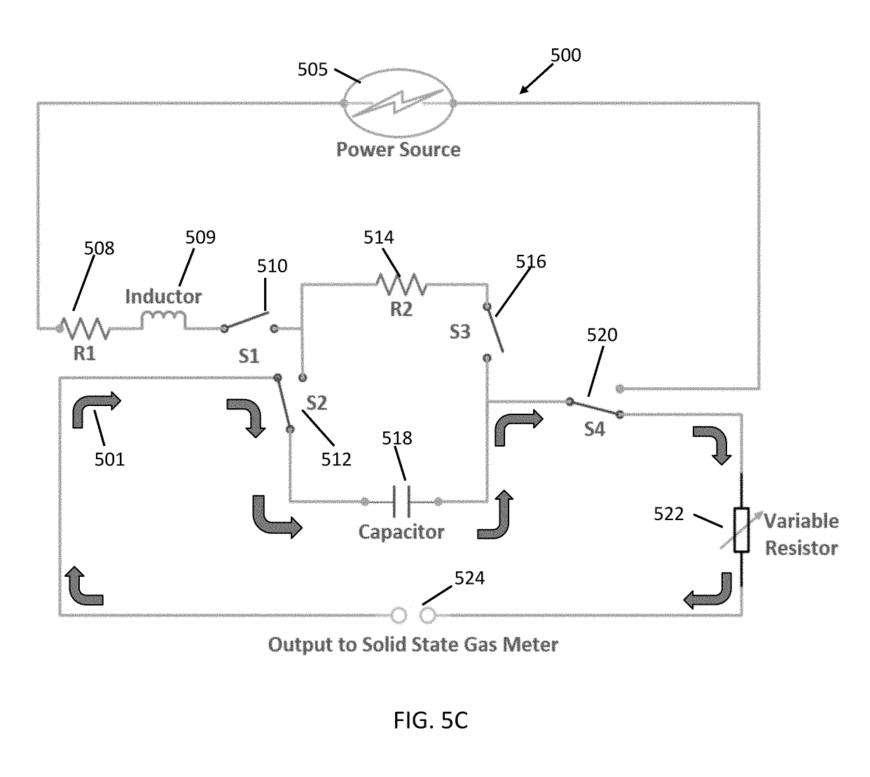

Some embodiments of the invention include one or more power charge operations or function control systems or components. For example, FIG. 5A includes a non-limiting example of power charge operation circuitry in accordance with some embodiments of the invention. In some embodiments, a solid-state resource meter (e.g., such as meter 101) can include the circuit 500, and/or can be integrated with the circuit 500, and/or can comprise the circuit 500 showing electricity flow 501. As shown, in some embodiments, the circuit 500 can comprise a power source 505, resistor 508, inductor 509, switches 510, 512, 516, and 520, capacitor 518, variable resistor 522, with output 524. In some embodiments, according to a specific charging state, the charge capacitor 518 can be charged by closing switches 510, 512, 516, and 520.

Referring to the power storage operation circuitry 525 of FIG. 5B, in some embodiments, the opening of switches 510, 512, 516, and 520 can enable electricity to be stored in the capacitor 518. FIG. 5C includes a non-limiting example of power discharge operation circuitry 550 in accordance with some embodiments of the invention. In some embodiments of the invention, in a discharge state, discharging electricity can be accomplished by closing switches 512 and 520, which closes the output circuit 551, and then using the variable resistor 522 to control the discharge. In some embodiments, the output 524 goes on to power a solid-state resource meter (e.g., meter 101) to transmit signals.

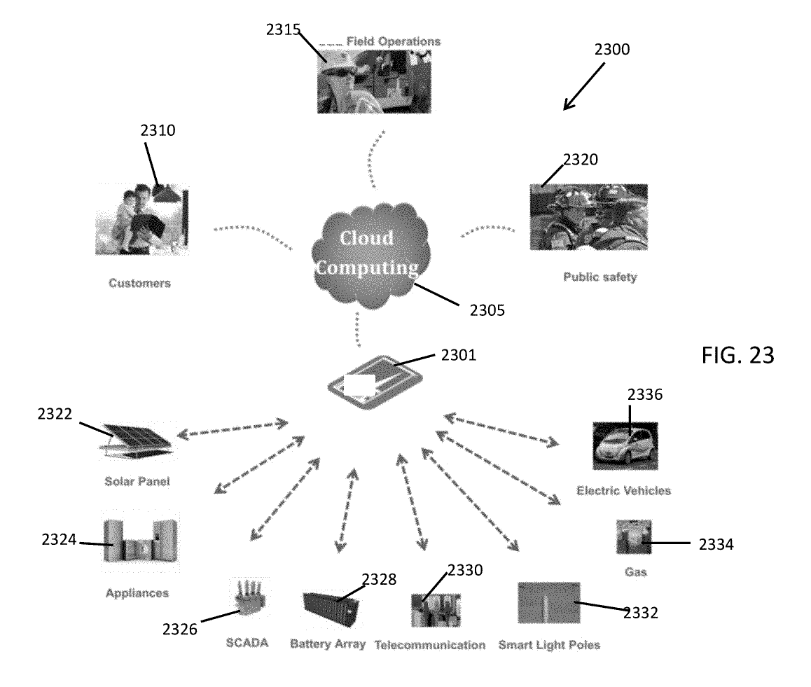

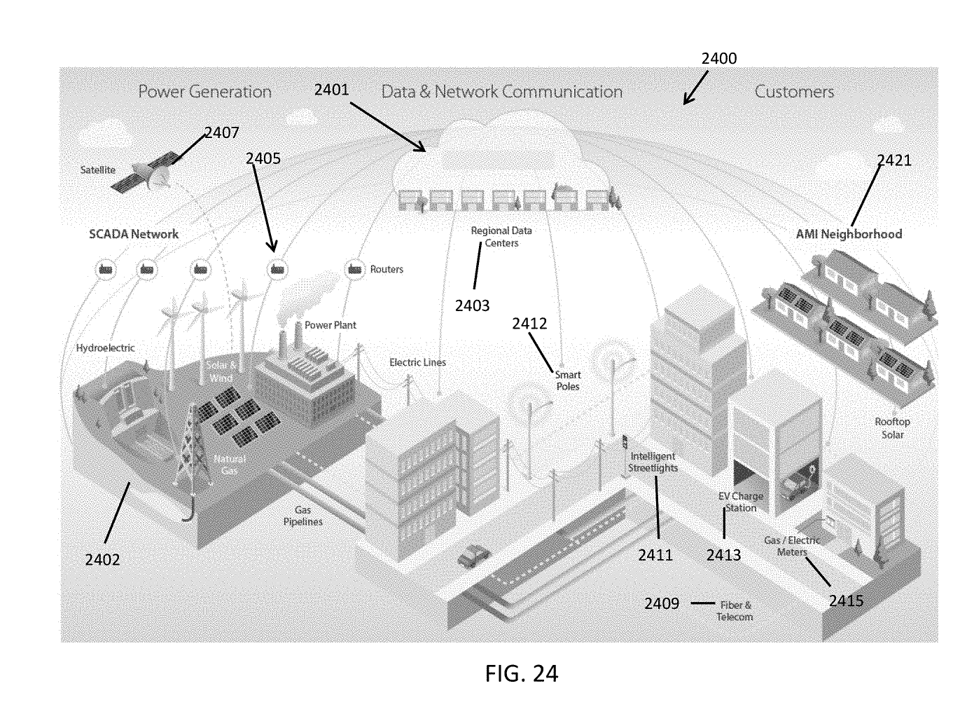

Some embodiments include one or more G-NGMs that can be networked to include one or more additional services for the user, including, but not limited to, internet service, home phone service, video monitoring or surveillance service, and other convention services. In some embodiments of the invention, the resource delivery and metering system can use at least one computing system within a cloud-based computing or server network (such as the systems of FIGS. 23 and 24). In some further embodiments, at least a portion of the network can include an artificial intelligence node or server. In some embodiments, resource delivery from one or more G-NGM' s can be controlled or managed with artificial intelligence through computer machine learning.

In some embodiments, any of the G-NGMs disclosed can provide one or functions, including, but not limited to, line voltage reporting, monitoring and control of resource distribution, real-time temperature reporting, measurements of acceleration, one or more communications systems, phone application and billing operability, multi-purpose metering, remote shut-off and turn-on, on-demand control, detection of wire-down events, monitoring of grid voltage, and improvement in reliability and grid operations and reporting, support of electric rule 21, detection of wildfires, detection of loose sockets, seismic data for grid planning and operations, field troubleshooting and electric operations assistance and/or monitoring.

Some embodiments include meters, assemblies, and methods for analysis of events and notifications generated by a resource meter (e.g., such as a “smart” meter and/or any of the meters described herein) during outages. In some embodiments, the system and methods include using data from smart electrical meter and system configurations to enhance distribution operator's ability to quickly identify hazardous energized wire down situations. In some embodiments, the meters, assemblies, and methods can enable rapid identification of primary distribution energized wire down locations. In some embodiments, the meters, assemblies, and methods of the invention can use signals and retrieved operational states from one or more meters to interpret the actual energized state of meters involved in an outage. In some embodiments of the invention, any electrical meters, assemblies, and methods described herein can be a voltage sensing device.

In some embodiments, the meter 103 can comprise any of the meters disclosed including meter 100, 102 and/or can include any one or more of the components or assemblies of meters 100, 102. In some embodiments, the meter 103 can include a remote shut-off and/or remote turn-on capability. In some embodiments, the meter 103 can comprise or be coupled to a phone application for billing and/or operations data. In some embodiments, remote accessible data can include average readings, minimum and maximum usage data, time synchronization diagnostic information, and maintenance record data.

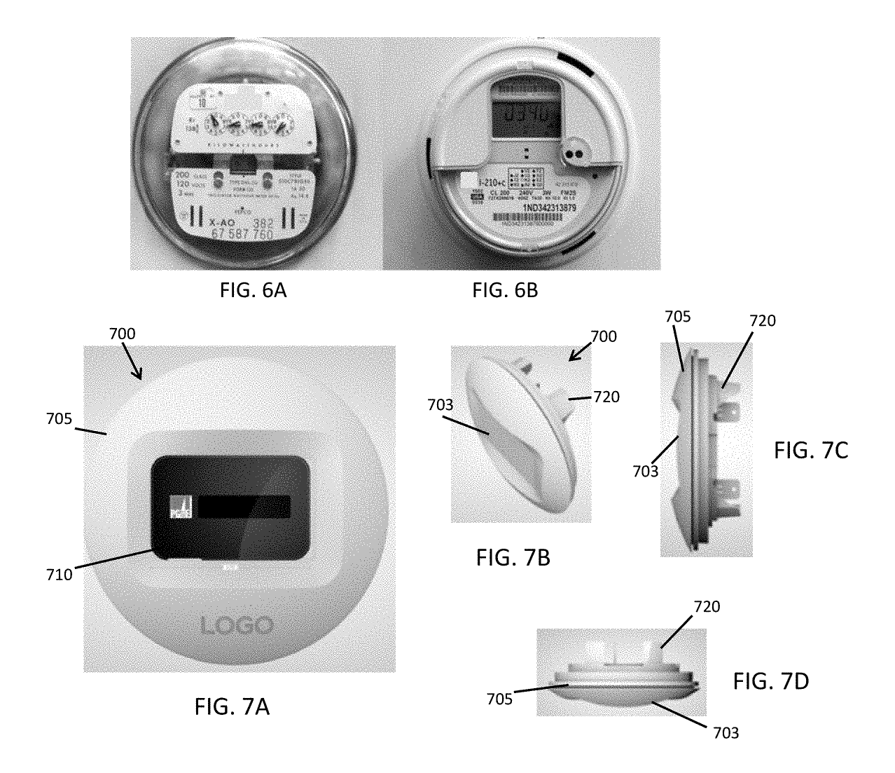

FIG. 6A and 6B show conventional meters, with FIG. 6A showing a conventional mechanical meter, and FIG. 6B showing a conventional solid state meter. The meters include a display that can show energy usage, instantaneous power, voltage, and direction of power flow (i.e., received power from a provided or delivered to a provider's grid). Meters of this type include an optical pick-up/pulse output used for programing the meter, and for testing the meter for accuracy. The meter can also include an advanced metering infrastructure (“AMI”) network communication card to remotely send energy usage back to the head-end system (e.g., as illustrated below in FIG. 24). The ampere rating is typically 200A maximum continuous. Other conventional traditional meters include transformer-rated meters coupled to a transformer for power that can provide the ability to provide an unlimited ampere rating with step down current transformers. The attachment of traditional self-contained meters to power infrastructure is usually accomplished using a pedestal mount which is bulky and the panel and construction cost is not insignificant.

Some embodiments of the invention described herein include improvements over the traditional self-contained meters and mounting solutions described above. For example, some embodiments include an electric meter end point hardware assembly including an electric meter socket and removable or portable meter. Some embodiments include a panel socket that in some instances can be a customer-owned device. The socket provides a coupling point for at least one electric meter end point hardware assembly. For example, some embodiments include a meter socket that can function as a hub, receptacle, and/or contact point for one or more further components of an electric metering system. In some embodiments, the meter socket can contain voltage and/or current sensors. Further, the meter socket can provide DC and/or induction power supply and female connection for other metrology and communication devices such as electric, gas, water, data, etc. In some embodiments, the meter socket can include at least one standard connection known in the art, at least one of which can be replaceable. The meter socket can include sensing of AC and/or DC values of phase voltage, phase current, and phase angle.

Some embodiments of the invention include meters that are packaged into a compact housing suitable for installation into or with any of the devices, components, systems, or structures described herein. FIG. 7A shows a front view of an electric meter assembly 700 in accordance with some embodiments of the invention. FIG. 7B shows a perspective view of an electric meter core base 705 with mounted or coupled electric meter 710 in accordance with some embodiments of the invention. FIGS. 7C-7D illustrate side views of the electric meter core base 705 of FIG. 7B in accordance with some embodiments of the invention. Some embodiments include a socket 720 that can function as a hub, receptacle, and/or contact point for one or more further components of an electric metering system. In some embodiments, the electric meter 710 can be coupled to the housing 705 and meter socket 720. The meter socket 720 can contain voltage and/or current sensors. Further, the meter socket can provide DC and/or induction power supply and female connection for other metrology and communication devices such as electric, gas, water, data, etc. In some embodiments, the meter socket can include at least one standard connection known in the art, at least one of which can be replaceable. The meter socket 720 can include sensing of AC and/or DC values of phase voltage, phase current, and phase angle.

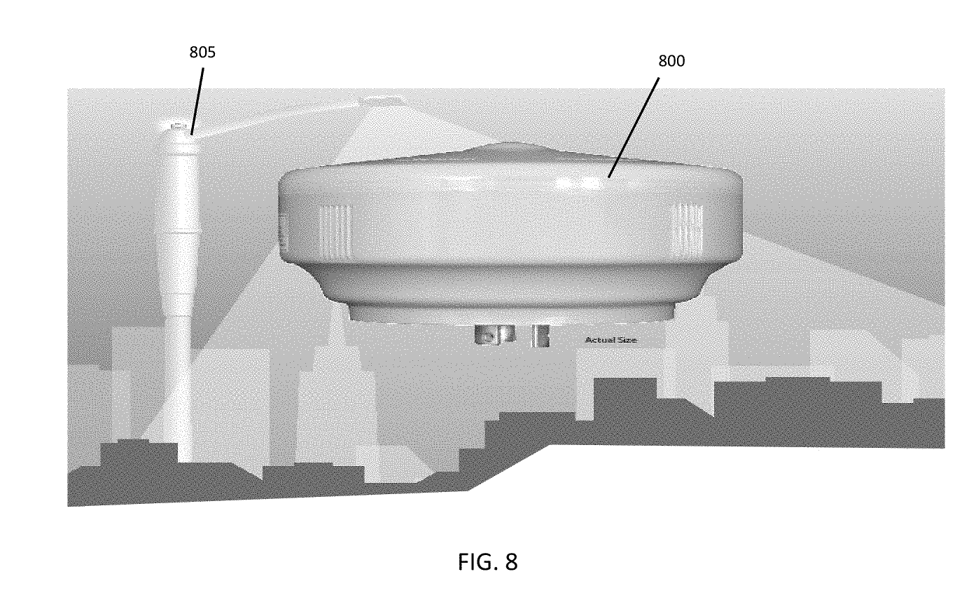

FIG. 8 illustrates an assembly view with a front side view of an electric meter 800 and utility or light pole 810 in accordance with some embodiments of the invention. In some embodiments, the electric meter 800 can be coupled or integrated to the utility or light pole 805. In some embodiments, the electric meter 800 can comprise the electric meter 710 and/or assembly 700. In other embodiments, the electric meter 800 can comprises any other of the meters described herein.

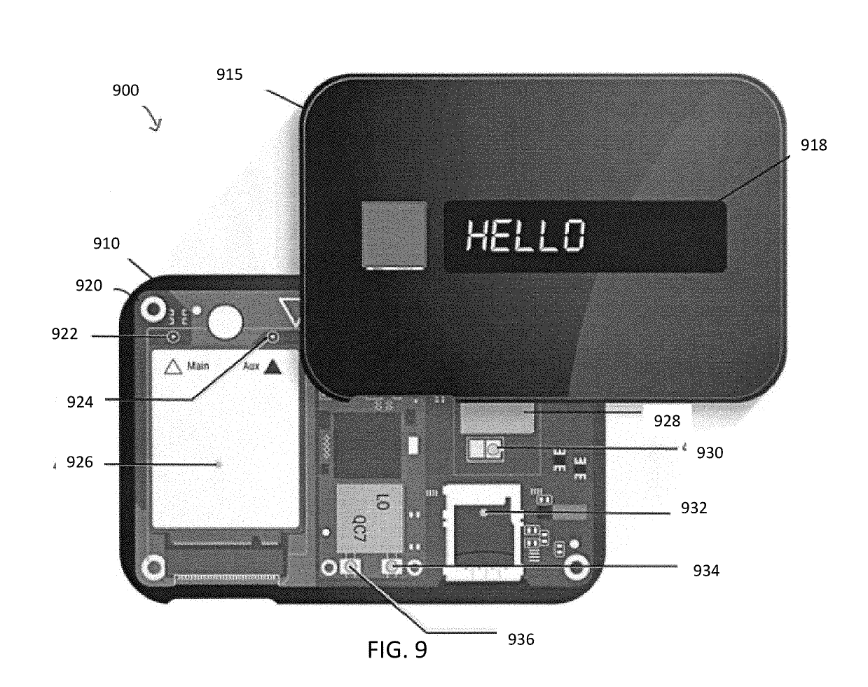

FIG. 9 illustrates an assembly view of an electric meter 900 in accordance with some embodiments of the invention. In some embodiments, the meter 710 can comprise the meter 900. In some embodiments, the electric meter 900 can include a base housing 910 that can be coupled to an upper housing 915. In some embodiments, the upper housing 915 can include a display 918. In some of the embodiments of the invention, the electric meter 900 can include board assembly 920 (shown mounted into base housing 910). In some embodiments, the board assembly 920 can include a plurality of integrated and/or mounted components, including, but not limited to, controllers, processors, receivers, transmitters, antenna, and memory. For example, in some embodiments, the board assembly 920 of the electric meter 900 can include components of an RF module include cellular antenna 922 (e.g., such as a 4G/LTE antenna), and/or a GPS antenna 924, and/or modem/receiver 926 (e.g., such as a 4G/LTE modem GPS receiver), and/or computing module 928, and/or antenna 930 (e.g., such as a ZigBee® antenna), and/or an SD card 932, and/or antenna 934 (e.g., such as a Bluetooth® antenna), and/or antenna 936 (e.g., such as a Wi-Fi antenna). Some embodiments can include a two-way inverter safety switch for inverter application for charge/discharge.

In some embodiments, any RF module can be coupled to a fixed energy or resource meter. For example, in some embodiments, the RF module can be mounted or otherwise coupled or integrated with a fixed energy meter. In some other embodiments, the RF module can be mobile and not mounted or otherwise physically coupled to an energy meter. In some embodiments, the RF module can be removably mounted or coupled to an energy meter. In some embodiments, when the RF module is mounted or coupled to the energy meter, information can be transferred between the energy meter and the RF module. In some embodiments, a user can move the RF module to within a specific distance from the energy meter to enable transfer of information between the RF module and the energy meter. The specific distance includes distances that are known in the art for RF data transmission distances for known RF standards (described below).

Some embodiments of the invention can include at least one RFID module that can provide tracking and asset management capability. Some embodiments of the invention also include an RF module that can provide sub-metering and communication interconnections between sub-meters and main meters, and interconnectivities with other sub-meters. Moreover, in some embodiments of the invention, the system can provide services such as Internet, home phone, TV, and/or video. For example, some embodiments include RFID tracking that can form a communication channel or link with an RFID reader. In some embodiments, the RFID module can comprise a variety of modules types, including common RF protocols and standards. For example, in some embodiments, the RFID module can include class 1 including a simple, passive, read-only backscatter tag with one-time, field-programmable non-volatile memory. Other embodiments can utilize class 2, a passive backscatter tag with up to 65 KB of read-write memory. Other embodiments can use a class 3: a semi-passive backscatter tag, with up to 65 KB read-write memory; essentially, and with a built-in battery. Some further embodiments include Class 4: an active tag with built-in battery, an internal transmitter for transmitting to the reader. Some further embodiments can implement a class 5: an active RFID tag that can communicate with other class 5 tags and/or other devices.

Some embodiments include RFID standards for automatic identification and item management (ISO 18000 series standards). Some embodiments of the invention include an 18000-1 standard that uses generic parameters for air interfaces for globally accepted frequencies. Some embodiments can use an 18000-2 standard with an air interface for 135 KHz. Some further embodiments can use a 18000-3 standard with an air interface for 13.56 MHz. In some further embodiments of the invention, standard 18000-4 can use an air interface for 2.45 GHz. In other embodiments of the invention, standard 18000-5 with an air interface for 5.8 GHz can be used. In some other embodiments, 18000-6 with an air interface for 860 MHz to 930 MHz can be used. In some alternative embodiments, standard 18000-7 with an air interface at 433.92 MHz can be used. In some embodiments, the RF module, an RFID module and/or the meter component of the system can include one or more security protocols. For example, some embodiments include advanced encryption standard (AES). Some embodiments can include performance of cryptographic challenge and response protocols, including dynamic challenge-response protocols.

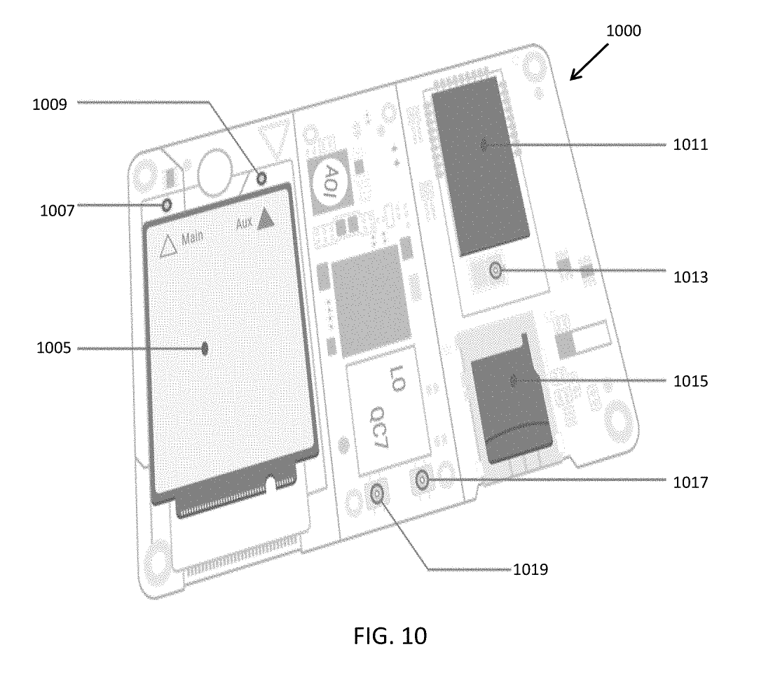

In some embodiments of the invention, the electric meter 710 and/or assembly 700, meter 800 and/ or 900 (or any one or more of the resource meters described herein) can incorporate various semiconductor technologies that enable mobility metering and broadband metering within an integrated device with reduced size compared with conventional metering systems. For example, in reference to FIG. 10, showing a non-limiting embodiment of a board architecture 1000 of the electric meter 900 of FIG. 9, some embodiments utilize various system-on-chip technologies that can integrate a variety functions that would normally reside in separate modules and/or coupled devices. In some embodiments, the system-on-chip systems can incorporate an operating system and a host interface along with data collection and error control processing. Further, the system-on-chip can integrate mobility and communications modules with seamless integration with the operating system, data collection, and host interface.

In some embodiments of the invention, the electric meter 710 and/or assembly 700, meter 800 and/ or 900 (or any one or more of the resource meters described herein) can incorporate integrated RF components and assemblies. For example, in some embodiments, the board architecture 1000 can comprise at least one RF related transceiver and associated antenna. In some embodiments, multiple frequencies can be supported. In some embodiments of the invention, the meter 900 or a resource meter assembly can comprise one or more components RF components.

In some embodiments, the RF components can be integrated with or coupled to the communication board and/or a metrology board. For example, some embodiments include RF components operating at a 2.4 GHz-ISM frequency band. Some embodiments include one or more integrated communication functions, including, but not limited to, licensed 400 MHz band, un-licensed 900 MHz band, Wi-Fi, Bluetooth®, ZigBee®, 4G cellular, RFID, and GPS. Some embodiments include an RF system and method of operation compatible with Bluetooth® and IEEE 802.11x within a mobile device. Bluetooth® is a registered trademark of Bluetooth® SIG Inc. ZigBee® is a registered trademark of ZigBee Alliance Corporation. Some embodiments include one or more wireless interfaces to a central system including legacy (e.g., Aclara Technologies, LLC, and Silver Spring Networks, Inc. as non-limiting examples), and/or (LTE/4G capable systems). Some further embodiments include an interface to home appliances for metering and control (e.g., using Bluetooth®, Wi-Fi, Wi-Sun). Bluetooth is a registered trademark owned by Bluetooth®SIG. As a non-limiting example, the board architecture 1000 of FIG. 10 can include at least one 4G/LTE modem GPS receiver 1005, and/or 4G/LTE antenna 1007, and/or GPS antenna 1009, and/or computing module 1011, and/or ZigBee® antenna 1013, and/or SD or SIM card 1015, and/or Bluetooth® antenna 1017, and/or Wi-Fi antenna 1019. Some embodiments include communications through a land-line such as a telephone line and/or a fiber optic cable.

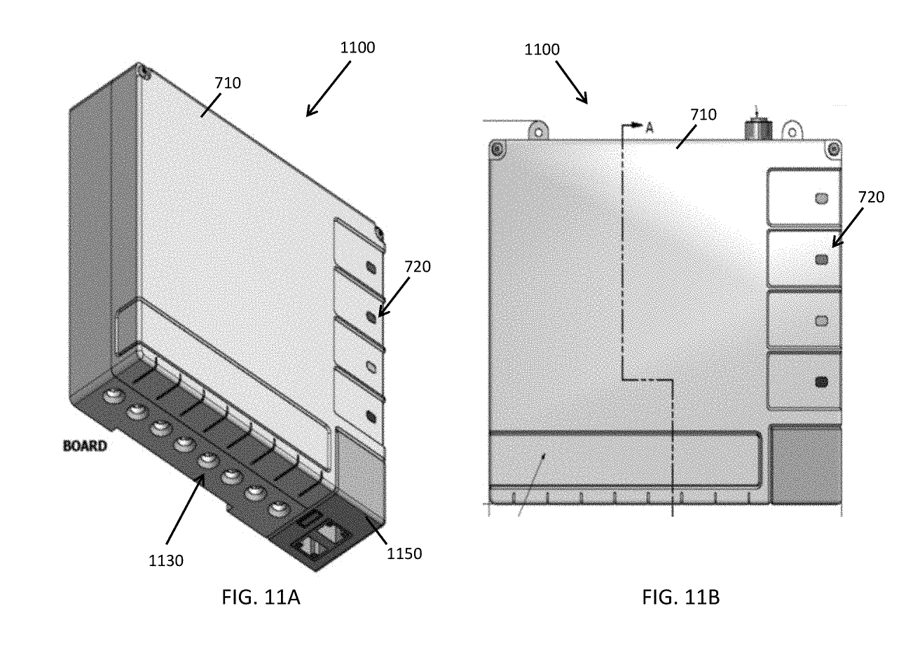

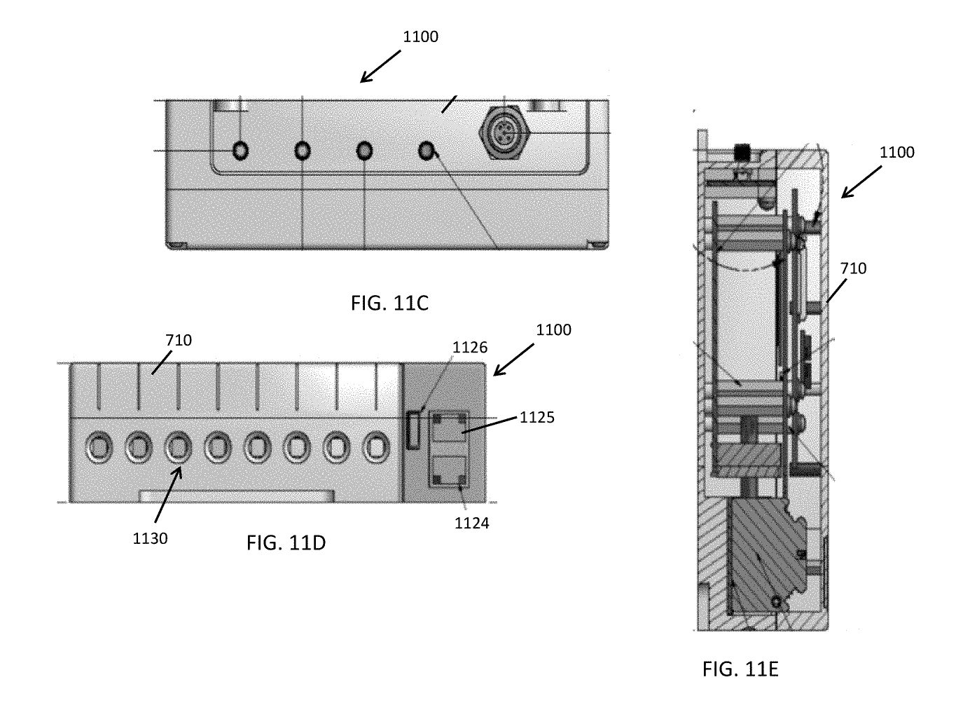

FIG. 11A shows a perspective view of an electric meter module 1100 in accordance with some embodiments of the invention. Further, FIG. 11B shows a top view of the electric meter module 1100 of FIG. 11A in accordance with some embodiments of the invention. FIGS. 11C-11D show end view of the electric meter module 1100 of FIG. 11A in accordance with some embodiments of the invention, and FIG. 11E shows a cross-sectional view of the electric meter module 1100 of FIG. 11A in accordance with some embodiments of the invention. In some embodiments, the meter module 1100 can comprise housing 1110 that can provide a mechanically and environmentally robust structure including various terminals, tabs, and/or connectors to enable the electric meter module 1100 to connect to AC power and to couple to external data input/output leads or other connectors. Other embodiments include one or more indicators that can provide information related to one or more functions of the electric meter module 1100. For example, some embodiments include indicators 1120 distributed on one side of the housing 1110, and other indicators such as indicators 1124. In some embodiments, the indicators 1120, 1124 can comprise a power indicator. In other embodiments, the indicators 1120, 1124 can include a status or operation of an RF transmission or receiving activity including, but not limited to, an LTE indicator, a Bluetooth® indicator, and a GPS indicator. Some embodiments include a plurality of edge connectors 1130, which in some embodiments, include power connectors, and other conventional connections, inputs and/or outputs. In some embodiments, the housing 1110 can be assembled and coupled using one or more fixing screws. In some embodiments, a terminal block cover can be positioned on the housing to cover or enclose one or more of the edge connectors 1130. Some further embodiments include a communication port panel 1150 positioned on one side or corner of the housing 1110. In some embodiments, the communication port panel 1150 can include miscellaneous communication ports, including, but not limited to, USB port (1126), a LAN port, and/or a WAN port (represented as 1125). Other embodiments include an SSN port extending through one side of the housing 1110.

Some embodiments include power transfer to or from a meter can be through or by an optical fiber cable. For example, some embodiments include a an optical cable (e.g., such as a fiber-type optical cable) that can carry and transfer optical power. In some embodiments, the optical fiber cable is used exclusively as an energy source. In other embodiments, the optical fiber cable can also carry or transfer data in addition to carrying or transferring power. In some embodiments, this can enable a component, assembly, or device to be remotely powered, while providing electrical isolation between the device and an A/C or DC power supply. In some embodiments of the invention, the voltage source can be 120 VAC. In other embodiments, the voltage source can be 240 VAC. In some embodiments, of the invention, power output can be 3 Vdc to 5 Vdc at 2 amperes. Other voltage inputs and power outputs outside of these values or ranges can be accommodated based as needed. In some embodiments, the maximum transfer length (from high voltage input to low voltage output) can be six inches. In other embodiments, the transfer length can be varied and may be more or less than six inches.

Some embodiments include a meter that can measure energy consumption in locations where multiple meters measure energy of multi-dwellings or situations such as apartment buildings, office buildings, multi-tenants smart poles, reducing the need for multiple single use meters in a given location. In some embodiments, the meter can be a credit card sized design for mobility.

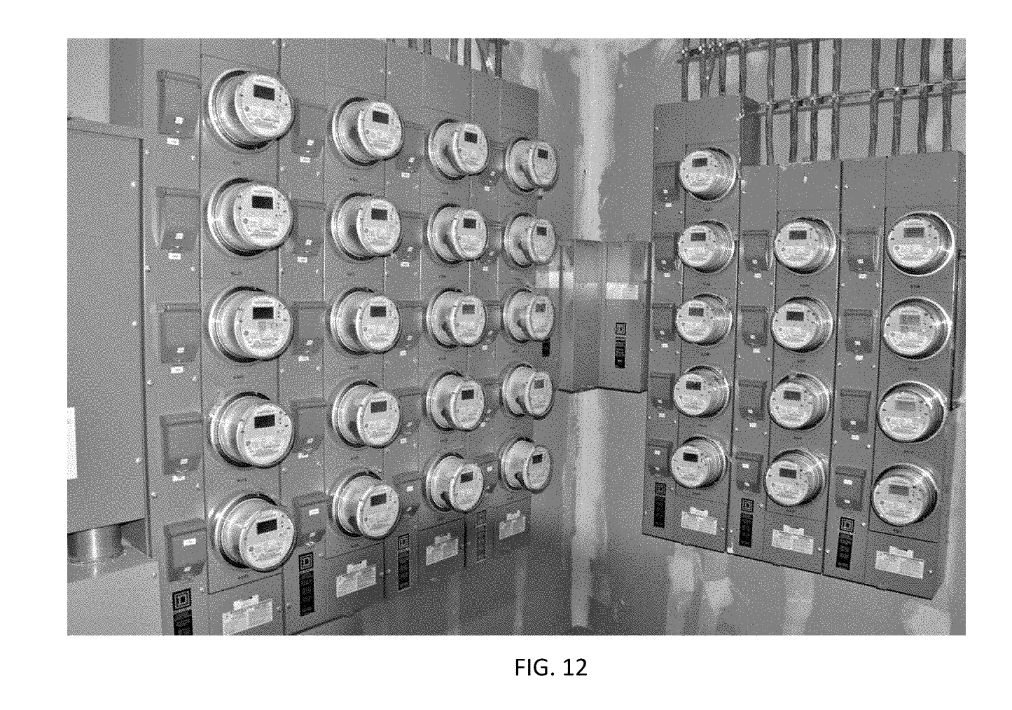

In some embodiments, a meter or metering system can comprise any one or more of the resource meters described herein, including, but not limited to gas meters, electric meters, and combinations of gas and electric meters. FIG. 12 is a perspective view of a conventional meter room, and is shown as an example of a commercial and/or larger residential building where many meters are stacked in rows and on one or two walls. The conventional technology utilizes a single meter for every tenant, resident, or consumer. Embodiments of the invention as disclosed below can replace and/or supplement the meters of FIG. 12 where one meter can serve more than one tenant, resident, or consumer. For the purposes of brevity, the term “consumer” will be used throughout to describe a user of energy being metered, where the user can be a person or persons, a company, or any other entity utilizing energy being measured or fed through the meter.

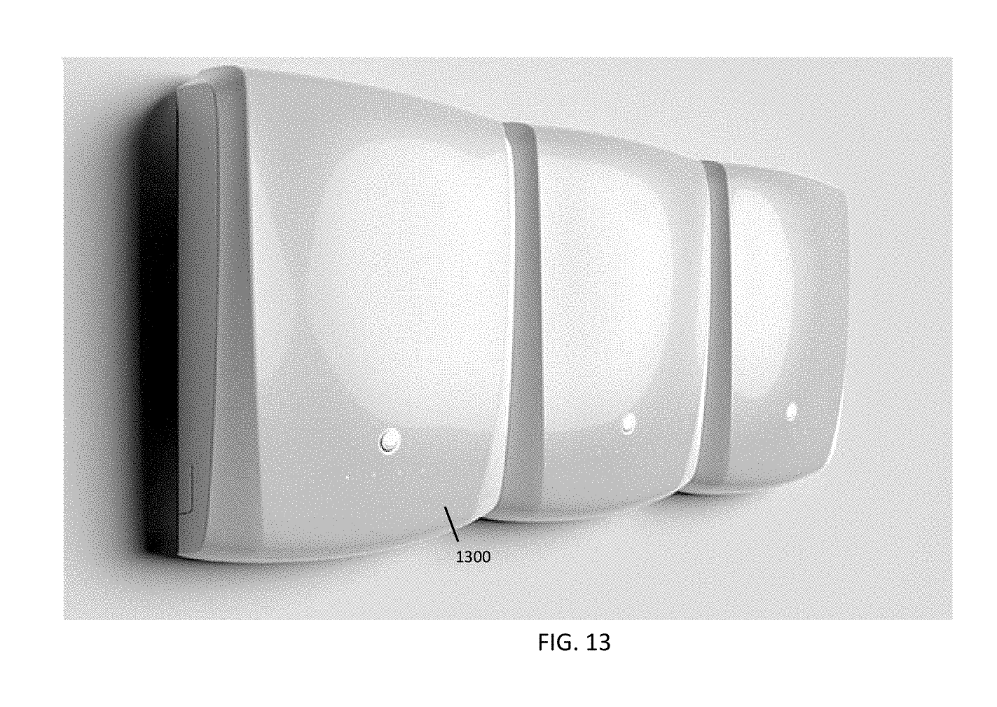

FIG. 13 is perspective view of a meter room of the future in accordance with some embodiments of the invention. In some embodiments, the meter room can include one or more cabinets 1300 housing meters serving a plurality of consumers or spaces. In some embodiments, the meter room can include at least one high voltage meter service cabinet, and at least one low voltage meter service cabinet. In some embodiments, the high voltage meter service cabinets and low voltage meter service cabinets can be substantially identically sized and shaped. In the non-limiting embodiments of FIG. 13, the cabinets 1300 comprise a generally rectangular box. In some other embodiments, the high voltage meter service cabinets and low voltage meter service cabinet can be sized and shaped differently. In some further embodiments, the cabinets can comprise a generally circular or square box. In some embodiments, the meter room can include a high voltage meter service cabinet and a plurality of low voltage meter service cabinets. In some other embodiments, at least one of the low voltage meter service cabinets can be coupled to the high voltage meter service cabinet. In some embodiments, the high voltage meter service cabinets and/or the low voltage meter service cabinets can include one or more indicators, buttons, and/or interfaces positioned on an outer face of the cabinet. In some embodiments, any status, function, activity alert and/or malfunction can be displayed on the one or more indicators and/or interfaces.

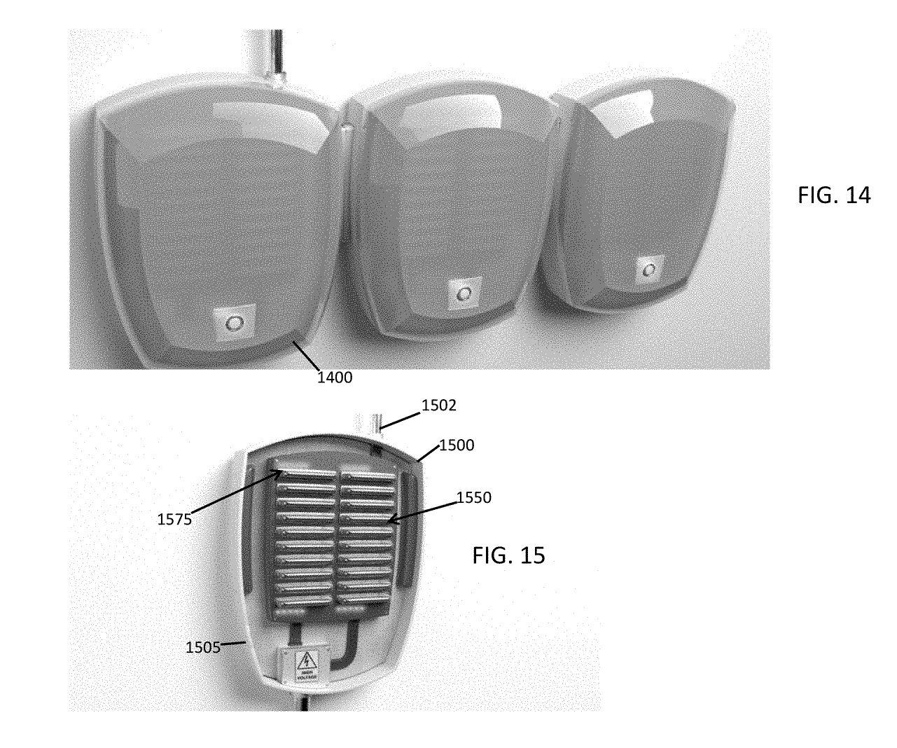

FIG. 14 is perspective view of a meter room in accordance with some further embodiments of the invention. In the non-limiting embodiment of FIG. 14, the cabinets 1400 of the meter room can comprise a curved rectangular box including a tapered profile. For example, in some embodiments, the upper end of the cabinets 1400 can comprise a width that is larger than the lower end of the cabinet (i.e., where the upper end is an end that is positioned on a surface higher than the lower end). In some embodiments, at least one of the cabinets 1400 shown can be a high voltage meter service cabinet, and/or at least one of the cabinets can be a low voltage meter service cabinet. In some embodiments, the high voltage meter service cabinets and/or the low voltage meter service cabinets can include one or more indicators, buttons, and/or interfaces positioned on an outer face of the cabinet. In some embodiments, any status, function, activity alert and/or malfunction can be displayed on the one or more indicators and/or interfaces. In some embodiments, some portion or all of the housing of the cabinets 1400 can comprise a non-transparent material. In other embodiments, some portion or the entirety of the housing of the cabinets 1400 can comprise a transparent or partially transparent material (as depicted in FIG. 14). In some embodiments, one or more meters of the cabinets 1400 can be at least partially viewable through the housing of one or more of the cabinets 1400.

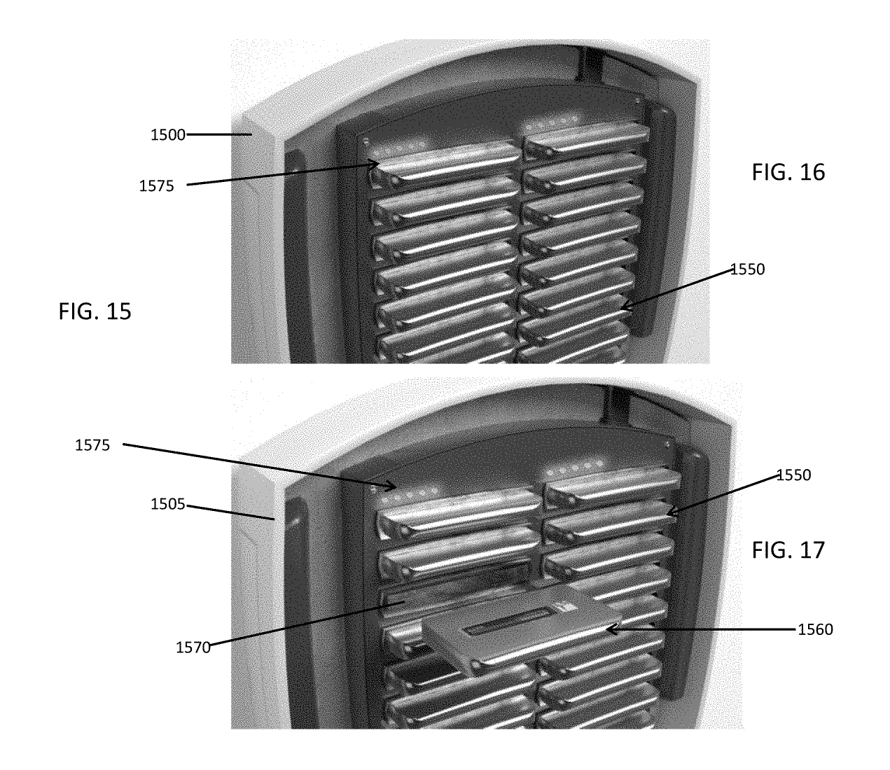

FIG. 15 is perspective view of a meter system 1500 with a front cover removed or absent in accordance with some further embodiments of the invention. In some embodiments, the meter system 1500 can include a plurality of meter modules 1550. As illustrated, in some embodiments, the meter system 1500 can include a plurality of indicator lights 1575 positioned within the housing 1505 of the meter system 1500 (e.g., where in some embodiments, each of the modules 1550 comprises an indicator light 1575). In some embodiments, one or more of the indicator lights 1575 can indicate a function, activity or status of one or more of the meter modules 1550. In some embodiments, the indicator lights 1575 are only visible in the housing 1505 with a cover removed as shown. In other embodiments, the indicator lights 1575 can be viewable through the housing 1505 (or cover).

FIG. 16 is a close-up perspective view of the meter system 1500 in accordance with some further embodiments of the invention, and FIG. 17 is a close-up perspective view of a meter module 1560 of the meter system of FIG. 16 in accordance with some further embodiments of the invention. As depicted, in some embodiments, the meter system 1500 can include a plurality of meter modules 1550. In this non-limiting embodiment, the meter modules 1575 can be arranged in two columns or banks extending from an upper end of the meter system to a lower end of the meter system. Further, in some embodiments, each column can include an associated set of indicator lights 1575. As shown in FIG. 16, in some embodiments, one or more of the meter modules (e.g., module 1560) shown can be removed, inserted, replaced, or exchanged into or out of a meter module slot 1570, with each meter module 1575 being positioned into a respective slot 1570 positioned in the base of the meter system 1500. In some embodiments, the meter system 1500 can be operational with all meter slots 1570 including a meter module 1575. In some embodiments, at least some of the meter slots 1570 can be empty whereas other meter slots 1570 can include a functioning meter module 1575. Some embodiments include a high voltage input and output from the meter system 1500. In reference to FIG. 15, in some embodiments, the meter system 1500 can include a high voltage supply line 1502 extending into the housing of the meter system 1500. In some embodiments, the high voltage supply line 1502 can be fed to one or more columns or banks of meter modules.

Some embodiments include a smart pole meter and/or EV sub-meter assembly comprising of the housing and other critical components that couple the meter core for customer metering solutions in “SmartPole”, “Smart Cities”, “EV sub-metering” applications etc. Some embodiments include docking stations that integrate a meter core for use with electric vehicles (“EVs”), smart poles, DER, sub-metering applications. In some embodiments, any of the meters and/or assemblies disclosed herein can improve safety through housing design, and can provide ease of field maintenance and replacement. Reduce material cost and truck rolls. In some embodiments, any of the meters and/or assemblies disclosed herein can reduce maintenance visits (truck rolls for example).

Some embodiments include integration or use with smart poles and smart cities, meter energy and support telecommunication cell sites electric vehicle charging station, with a reduced pedestal size. Some embodiments include electric vehicle charger sub-metering that can eliminate the second meter panel and simplify meter installations.

Some embodiments include a transformer-rated meter socket/meter assembly with coupled smart meter with a coupled meter. In some embodiments, the meter socket can include a main housing comprising an electrical box with a socket interface that can provide a coupling point for at least one electric meter end point hardware assembly. Consequently, in some embodiments, the meter socket can function as a hub, receptacle, and/or contact point for one or more further components of an electric metering system, and the smart pole meter can be coupled in close proximity to a transformer. In some embodiments, a transformer-rated smart pole meter socket can comprise an assembly that can be used to mount a transformer-rated meter, typically used in smart pole applications.

In some embodiments, transformer-rated meter socket/meter assemblies can comprise a current transformer with a ratio of between 50:5 and 200:5, an electrical box, a custom 4 pole meter socket with automatic current transformer (“CT”) shunt circuit, and a mounting plate, which can be adapted to any mounting hole pattern. In some embodiments of the invention, the current transformer can be mounted directly to the mounting plate, above the meter socket electrical box. The CT is used to step down the service current from up to 200 A to 5 A. The 5 A secondary is required to bring the measured current down to a level suitable for the meter to measure. The electrical box houses the wiring required to get the voltage and current to the meter socket, and then to the meter. In some embodiments, the electrical box can house the wiring required to get the voltage and current to the meter socket, and then to the meter. In some embodiments, the meter socket can be made up of a modified ANSI 19-20 twist-lock female four pole connector. In some embodiments, the connector can be physically modified on the upper section to allow clearance for the bottom face of the meter. Further, in some embodiments, it can be mechanically modified to allow for two redundant custom designed plunger switches to protrude through the top of the connector. In some embodiments, the connector can be rated for 480 VAC and 20 AAC.

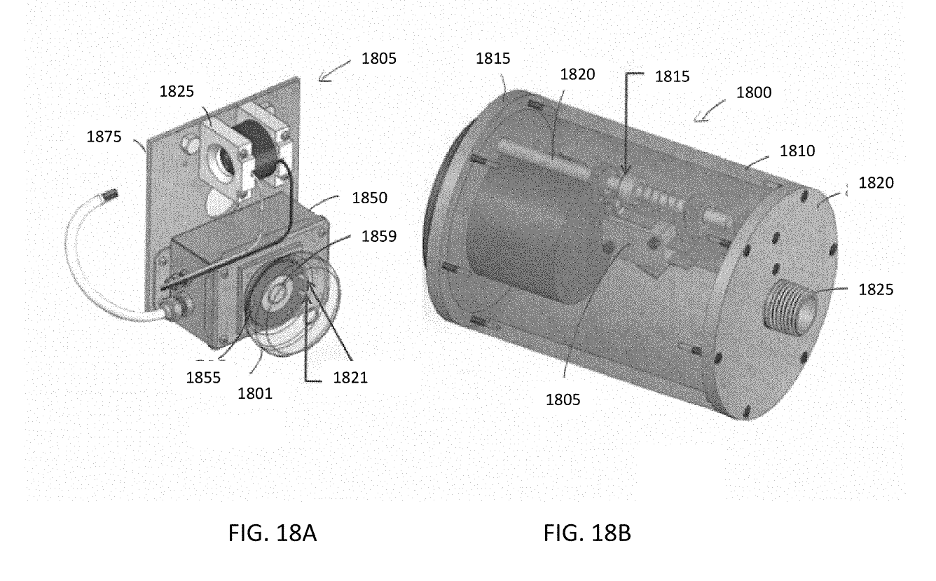

Some non-limiting embodiments include a pin-socket enclosure of smartpole meter or EV sub-meter. In reference to FIG. 18A, illustrating a transformer-rated meter socket assembly in accordance with some embodiments of the invention, and an internal view and design of the pin-socket enclosure shown in FIG. 18B, showing a partially transparent transformer-rated plunger switch in accordance with some embodiments of the invention. The meter 1801 is shown as partially transparent revealing the ends 1821 of the plunger actuator shaft 1820 (FIG. 18B) with contacts 1815. When the meter 1801 is positioned coupled to a socket interface 1859 as shown, electrical current can flow to the meter 1801, and when the meter 1801 is separated from the socket interface 1855 electrical can flow through the CT shunt 1805 (FIG. 18B). In some embodiments, the secondary housing 1800 comprises a generally cylindrical wall 1810 capped by a first end 1815 and a second end 1820 positioned in the transformer-rated meter socket 1850 with the first end 1815 supporting the adaptor socket 1859, and the second end 1820 adjacent the platform 1875 and secured using coupler 1825. During operation, in an open operation condition, the current can flow to the meter 1801 when it is in normal operation. In a closed operation, current can flow safely to ground to prevent electric shock to maintenance personnel.

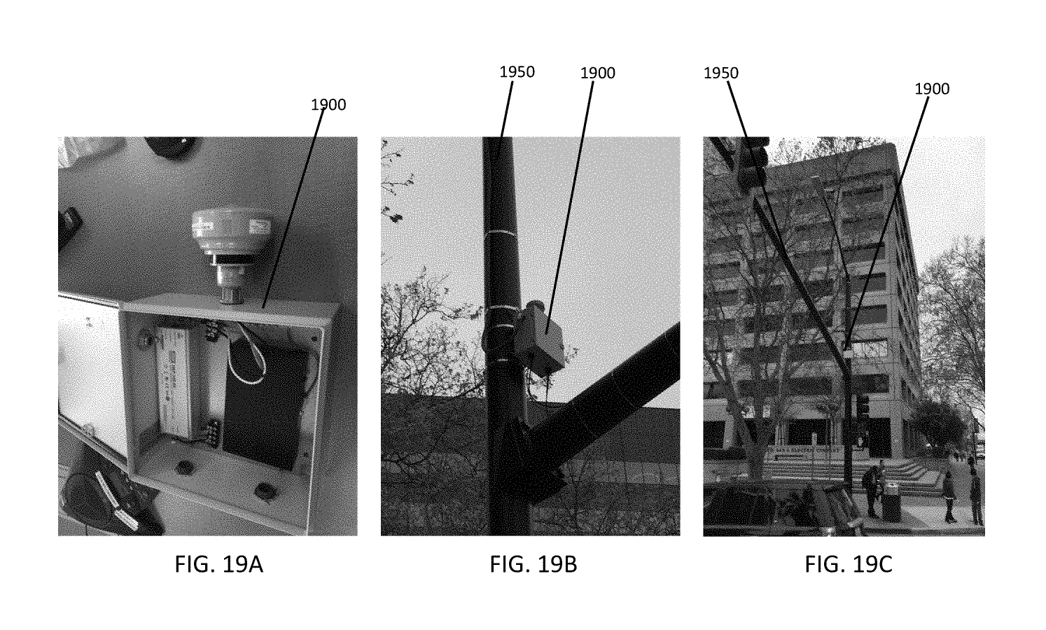

FIG. 19A illustrates an assembly 1900 of a multi-node wireless system with coupled electric meter in accordance with some embodiments of the invention. FIG. 19B shows a close-up view of the assembly 1900 of FIG. 19A mounted to a pole 1950 in accordance with some embodiments of the invention. FIG. 19C shows a view of the assembly 1900 of FIG. 19A mounted to a pole 1950 in accordance with some embodiments of the invention.

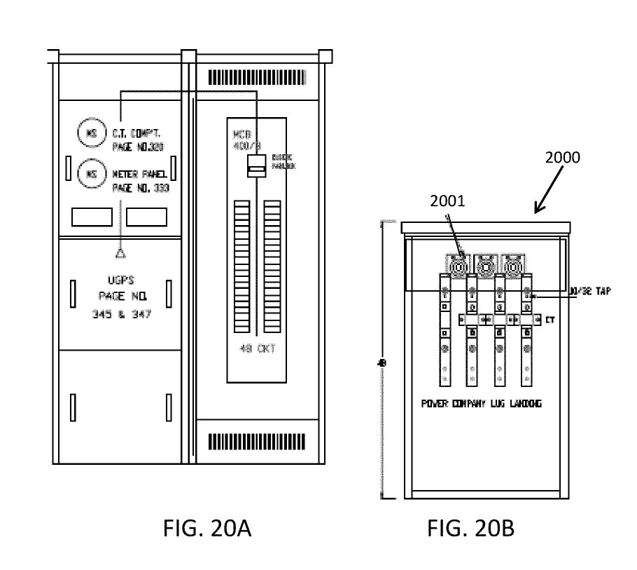

In some embodiments, features of meters and/or panels and assemblies with one or more meters can include an advanced metering infrastructure (“AMI”) network communication board or card that can be used to remotely send energy usage back to the head-end system. In some embodiments, the current class can be 16 A, and/or the voltage class can be 120V and 240V. Some embodiments include any of the energy measurement data described herein. Some embodiments include a standard NEMA 4-pin twist lock socket. FIG. 20A shows a conventional electric vehicle panel in accordance with some embodiments of the invention. However, FIG. 20B shows a non-limiting embodiment of the electric vehicle panel 2000 in accordance with some embodiments of the invention, with one or more meters 2001, which in some embodiments, can be coupled meters 1801 shown in earlier, meters 2100 (described below), or any other electrical meter described herein.

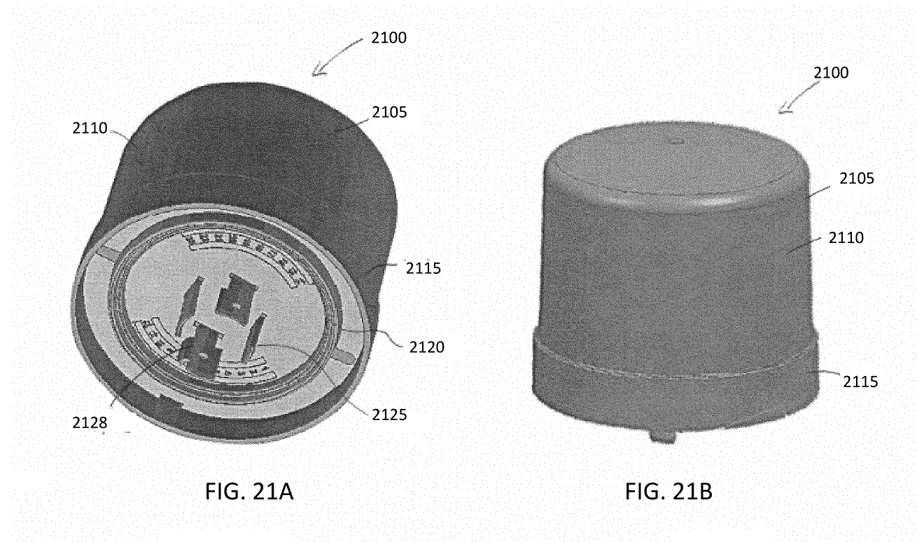

In reference to FIG. 21A illustrating a bottom perspective view of smart pole meter in accordance with some embodiments of the invention, and FIG. 21B illustrating a side perspective view of smart pole meter in accordance with some embodiments of the invention. In some embodiments, any meter described herein can be coupled to a socket by inserting one or more prongs into one or more inlets of an adaptor socket of the socket interface. In some embodiments, a meter 2100 can comprise a housing 2105 including an upper portion 2110 coupled to a lower portion 2115. Further, in some embodiments, the meter 2100 can comprise a socket interface 2120 and a plug assembly 2125 extending from the interface 2120.

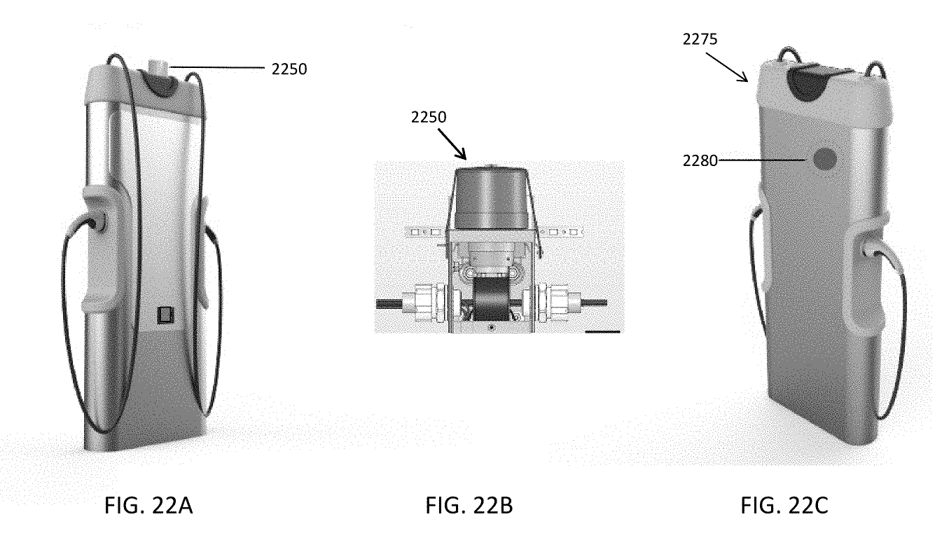

In some embodiments of the invention, any of the electric meter embodiments described herein can be integrated or otherwise couple with or into an electric vehicle charging station. For example, FIG. 22A illustrates a conventional electric vehicle charging station with mounted electric meter 2250 in accordance with some embodiments of the invention, and FIG. 22B illustrates the electric meter 2250 in accordance with some embodiments of the invention. Further, FIG. 22C illustrates a non-limiting embodiment of an electric vehicle charging station 2275 with representation of an integrated electric meter (representative internal region 2280 shown where the meter 2250 would be integrated) in accordance with some embodiments of the invention. In some embodiments, the meter 2250 can be integrated within other regions of the station 2275.

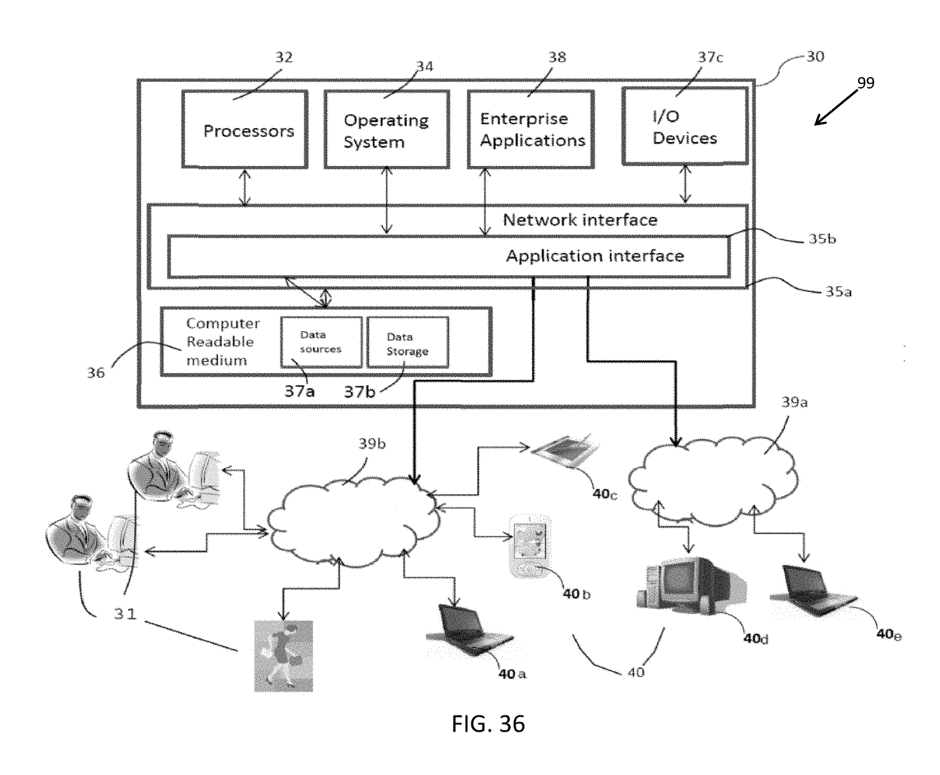

In some embodiments of the invention, a metering system architecture of the invention can be modular and enable mobility, and be configured for multi-network and cloud-computing. In some embodiments of the invention, one or more components, modules or assemblies of the electric metering system can form part of a cloud-computing network. In some embodiments, cloud-computing (e.g., in the form of one or more cloud computers, one or more cloud servers, and/or one or more cloud storage devices) can be used to store, process, and transmit information to and from at least one component, modules or assembly of a resource metering system. For example, FIG. 23 illustrates a system network 2300 including an electric meter 2301 in accordance with some embodiments of the invention. In some embodiments, the network can comprise a cloud computing system or server 2305 coupled to one or more electric meters 2301. In some embodiments, the user can access the meter and/or any data from the meter using a customer mobile application. In some embodiments, options for customer interface through the use of mobile applications can be accommodated using the cloud-computing system network. In some embodiments, the customer 2310 can deploy at least one resource meter at, for example, a fixed location (such as a residential or commercial building or business), and monitor a variety of parameters obtained from the meter at the location or at a remote location using a mobile device. For example, in some embodiments, a customer 2310, operations personnel 2315, and/or public safety staff 2320 can use a mobile laptop computer and/or mobile phone or smart phone to monitor at least one parameter of the resource meter 2301. In some further embodiments, personal digital assistants, pagers, digital tablets, or other processor-based devices can be used to access the cloud resource either through a wireless (e.g., a cellular or Wi-Fi signal) or through a wired link coupled to the cloud computing system or server. In some embodiments, the computing system or server can comprise the computing system 99 of FIG. 36 as described below.

In some embodiments, the system can perform, provide, store, and poll/communicate/transfer routinely, on demand, and ad-hoc the telecommunication bits/bytes metrology in utility cloud-computing and/or in the meter. In some embodiments of the invention, power quality information voltage, current and phase angle values at a user-specified interval, and/or sampling technique on phase voltage and current wave forms can be used by the system to provide a variety of energy metrics. For example, in some embodiments, the system can calculate the energy usage, and/or interval temperature, electric energy kWh and kVARh values in a user-specified period, and/or electric service analyses and information to detect wrong meter base installations, and/or electric service analyses and information to detect tampering and provide potential tampering leads. For example, in some embodiments, through at least one cloud resource (e.g., such as a cloud-based serve and/or computing system), one or more electric meters can couple to a utility data management system such as utility data management and transmit the variety of parameters mentioned earlier. In this instance, information such as energy use (kWh and kVARh), operation function such as real time (or substantially real time) voltages and current, and grid awareness such as the physical location of a mobile electric meter can be processed through the cloud resource linked with a utility data management (system utility data management).

Some embodiments can include provisions for phase voltage, current and phase angle in real (or substantially real) time in a full scale, or by designation or during emergency and/or power outage and restoration situations. In some embodiments, computation of kWh consumption and other power metrics can be done by cloud-computing with various communication back-haul options. This embodiment exemplifies a very different philosophy from the more typical “smart meter” philosophy by performing analyses and computations in the cloud instead of at the meter.

In some embodiments, the electric metering system can function as a telecommunication conduit for other services such as internet, video, TV, advertisements, etc. Moreover, in some embodiments, using customer identification information, the electric metering system can function as a telecommunication conduit for services (i.e. internet, video, TV, advertisements, etc.) that are tailored or targeted to the customer's needs, preferences, or geographic location. In some embodiments, the system can generate licensing fees for revenues that can help lower the customer's energy rate. Further, in some embodiments, the system can enable customers to be informed about commercial services (e.g. shopping), public safety (i.e. police, fire, hospital, etc.), and can be used to improve public and personal safety (i.e. in emergency situations, such as accidents, stranded vehicles, etc.) Some embodiments can also include electrical outage and gas/water leakage monitoring and/or call notifications and identifications. Further, some embodiments can function as or couple to telecom hubs that can provide improved bandwidth for field personnel communications and provide mobile telemetry. In some embodiments, the system can provide local, area-wide, and/or global Internet services.

In some further embodiments, the meter can be associated with or coupled to an electric vehicle, and/or an electric charger, and/or battery storage, and/or a photovoltaic system, and/or a circuit breaker, and/or appliances, and/or infrastructure. In the latter example embodiments, a mobile energy meter and remote application can be used to guide customers when and where to plug in either to charge or discharge, and potentially lower operating/maintenance cost of an electric vehicle. In some embodiments, this can enable customers and utilities to better manage EV loads (when charging) and generations (when discharging), and help lower costs of the grid construction, maintenance and operation. Thus, in some embodiments, EVs with embodiments of the mobile meters described herein can support and benefit the electrical grid system, and customers can be provided with real time charging/discharging cost and kWh quantity. Further, in some embodiments, the electric metering system can function to provide vehicle telemetry and/or form part of a self-driving infrastructure. In some embodiments, using a combination of smart poles and/or micro cell sites, the electric metering system relay vehicle telemetry information, and provide remote monitoring of charge/ discharge within an electric vehicle route. Furthermore, because the cloud-based system can be managed and/or coupled to at least one utility data management system, the system can be used to guide customers when and where to plug in either to charge or discharge based on location, charging station status, local and area-wide grid loads, etc., providing real time location based charge/discharge updates, operating with real time data on the grid.

In reference to FIG. 23, as a non-limiting example, embodiment of the invention, the meter system architecture 2300 can be mounted or coupled to multiple applications such as buildings, homes, appliances, circuit breakers, PVs, battery storages, EVs, charging stations, microcell tower/pole, etc. For example, some non-limiting examples include can include one or more meters 2301 couple to the cloud computing system or server 2305, and couple to one or more of solar panels 2322, appliances 2324, SCADA 2326, battery arrays 2328, telecommunication systems 2330, smart light poles 2332, gas systems 2334, and/or electric vehicles 2336. In some embodiments, a customer 2310, operations personnel 2315, and/or public safety staff 2320 can use a mobile laptop computer and/or mobile phone or smart phone to monitor at least one parameter of one or more resource meters 2301 coupled to or associated with one or more of the solar panels 2322, appliances 2324, SCADA 2326, battery arrays 2328, telecommunication systems 2330, smart light poles 2332, gas systems 2334, and/or electric vehicles 2336.

As a further non-limiting embodiment, the FIG. 24 shows a non-limiting embodiment of a system architecture 2400 in accordance with some embodiments of the invention. In some embodiments, the meter system architecture 2400 can comprise the meter system architecture 2300. In some embodiments, one or more meters and/or panels and assemblies with one or more meters can include an advanced metering infrastructure (“AMI”) network communication system 2401. In some embodiments, that can comprise an AMI mesh (electric), AMI point-to-point (gas +electric), and/or a 4G LTE capability operating in real time. Further, some embodiments include one or more regional data centers 2403 that can be used to remotely monitor and delivery a resource and/or allow control or access of a user systems or components or resource users (consumers coupled to smart poles 2412, intelligent streetlights 2411, such as EV stations 2413, one or more houses or buildings in a neighborhood 2421, resource meters (e.g., gas or electric) 2415, and resources generators 2402 (e.g., such as hydroelectric, solar and wind generators, natural gas generators, power plants, etc.) For example, some embodiments include one or more communications systems of links including a SCADA network, routers 2405, satellite links 2407, fiber and telecommunication links or systems 2409, coupled one or more users, resource meters, resource generators, etc., to and through the network 2401. In some embodiments, the meter system architecture 2400 can comprise any of the embodiments of resource meters described herein for use in metering resources, monitoring resources, and providing alerting and usage functionality as described earlier.

Some embodiments include a training and practical assessment system and method for metering personnel who may be routinely exposed to hazardous voltages with enough energy to create arc flashes, injury personnel and cause property damage. Some embodiments include a portable device that can simulate various electrical metering field conditions. For example, some embodiments include a software driven tester that can electrically model various field conditions for technician assessment and training. In some embodiments, these models can be pre-programmed and sequenced for testing or Ad-hoc models can also be generated. In some embodiments, the system has the necessary communications and allows the simultaneous and independent testing of up to six technicians

In some embodiments of the invention, the training and practical assessment system and method for metering personnel can comprise a system size and weight that can allow transport in one conventionally sized vehicle. In some embodiments of the invention, the main system components can include, but not be limited to, a power supply (marked as 2503) such as an Omicron CMC 356 (from OMICRON electronics Corp. USA). Some further embodiments include a controller (marked as 2502) such as a National Instruments (Austin, Tex.) NI PXIE controller. In some embodiments of the invention, the training and practical assessment system and method for metering personnel can comprise a NI-PXI-8820 2.2 GHZ Celeron® 1020E dual core, and/or NI PXI-2567 64 channel relay driver modules (4), and/or NI PXI-6224 DAQ/DIO, and/or a NI-PXI-6535 high speed digital I/O. Celeron is a trademark of Intel Corporation or its subsidiaries in the United States and elsewhere.

Some embodiments can utilize LabVIEW® software. LabVIEW® is a registered trademark of Tektronix, Inc. Some embodiments include a metering operational assessment tester (“MOAT”) application. Some embodiments include a LabView program “MOAT” that runs on the National Instruments PXI Controller. In some embodiments, this software can be configured to route the requested voltage signal to each meter jaw, and/or notify the trainee when any meter socket is energized, and/or notify the trainee when the problem is ready for evaluation, and/or program the power supply (2503) to generate the appropriate voltages (magnitude and phase). Some embodiments of the system provide physical indication to the trainee on a problem number. Some embodiments run through a pre-programed sequence of problems. Some embodiments only energize active test stations. Some embodiments allow for the simultaneous testing of six technicians while only requiring one trainer (shown as 2505).

Some embodiments include one or more programming test scenarios. In some embodiments, the software can be configured to sequence through programmed steps, progressing at the pace of the trainee 2507, 2509, 2511, 2513, 2515, 2517. Listed below are some of the routines which run to setup the system and present the scenarios to the trainee(s). For example, some embodiments can confirm communications with the power supply 2503. Some embodiments can comprise one or more steps of actions such as select active test stations, select voltage sources, send voltage amplitude and phase information to power supply. Further, some embodiments can comprise one or more actions such as: confirm voltages are within tolerances, energize relays to route signals from power supply to specific meter jaws, and/or notify trainees of socking becoming energized. Some embodiments can comprise one or more actions such as: route selected voltages to all meter jaws, provide indication of question and problem status, query trainee for permission to move on, de-energize all meter jaws, de-energize all test stations, and/or reset for next program.

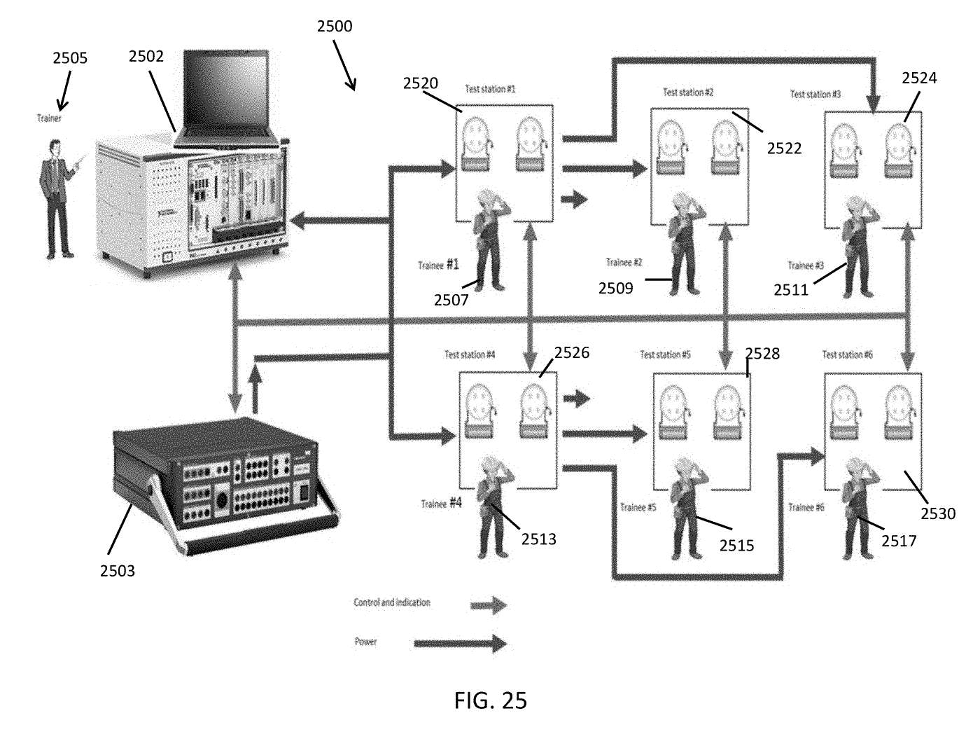

FIG. 25 illustrates a metering operational assessment tester (MOAT) graphical diagram 2500 in accordance with some embodiments of the invention. As illustrated, some embodiments include test stations comprising up to six trainee test stations (shown as 2520, 2522, 2524, 2526, 2528, and 2530), with each test station associated with a trainee (shown as 2507, 2509, 2511, 2513, 2515, 2517), where each test stations consists of one four and one five jaw meters sockets. In some embodiments, the system can model the electrical characteristics of forms 1S, 2S and 12S electricity meters. In some embodiments, there can be two models of test stations such as a parent and child.

Some embodiments including parent workstations can comprise two parent workstations that are connected directly to four voltage sources of the power supply 2503. Since each workstation requires two independent voltage sources and the Omicron can generate four separate voltages, this provides the capability to run 2 independent sets of electrical models simultaneously. In some embodiments, the parent workstations can provide voltage and communications connections for the child stations. In some embodiments, the child workstations can comprise four workstations coupled to a parent workstation that can mirror the electricals signals of the parent workstation. In some embodiments, each parent workstation can support up to four child workstations. Finally, in some embodiments, each child station can have the capability to disconnect from the parent for electrical safety if a child is not needed.

Some embodiments include one or more modules that can be used in the workstations. Some embodiments include a display or trainee interface. In some embodiments, this module provides indications to the trainee for socket voltage status, and/or assessment question number, and or socket simulation condition. Further, some embodiments allow the trainee to communicate to the proctor. Some embodiments include an assessment question status and/or an instructor call. And some embodiments include one each of this module on every workstation.

Some embodiments include a socket jaw controller. In some embodiments, this module can control which signal is routed to each meter jaw. In some embodiments, the options can be L1, L2, neutral and ground. In some embodiments, only the parent has this module as the child workstations can mirror their respective parent. In some embodiments, there are nine each of these modules for each parent workstation.

Some embodiments include a voltage selection. In some embodiments, this module can determine which two of the four available voltages are routed to each parent workstation. In some embodiments, this module can control the connection of the neutral and ground connections. In some embodiments, there can be one each installed on each parent workstation.

Some embodiments include a child power control. In some embodiments, this module can independently control the connection of each jaw of the child to the same electrical source as it's respective parent workstation. In some embodiments, this can allow an unneeded child module to be disconnected electrically to eliminate any electrical hazards. In some embodiments, there can be one child power control module for each child meter socket.

In some embodiments, the emergency shutdown system can de-energize all power to every workstation once activated. In some embodiments, each workstation can be equipped with an emergency button which can trigger an emergency shutdown.

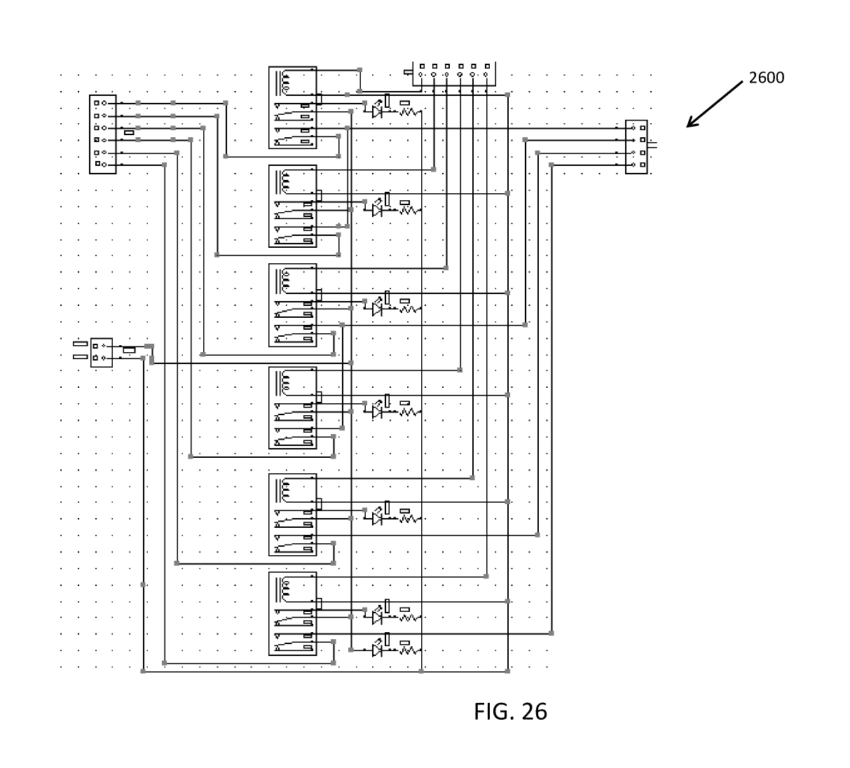

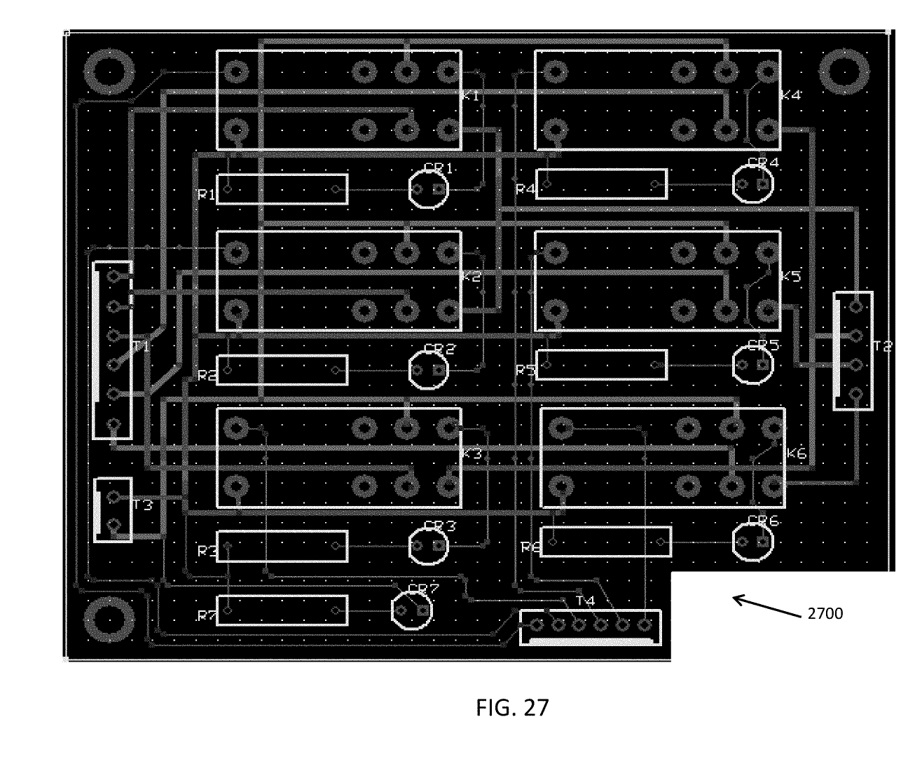

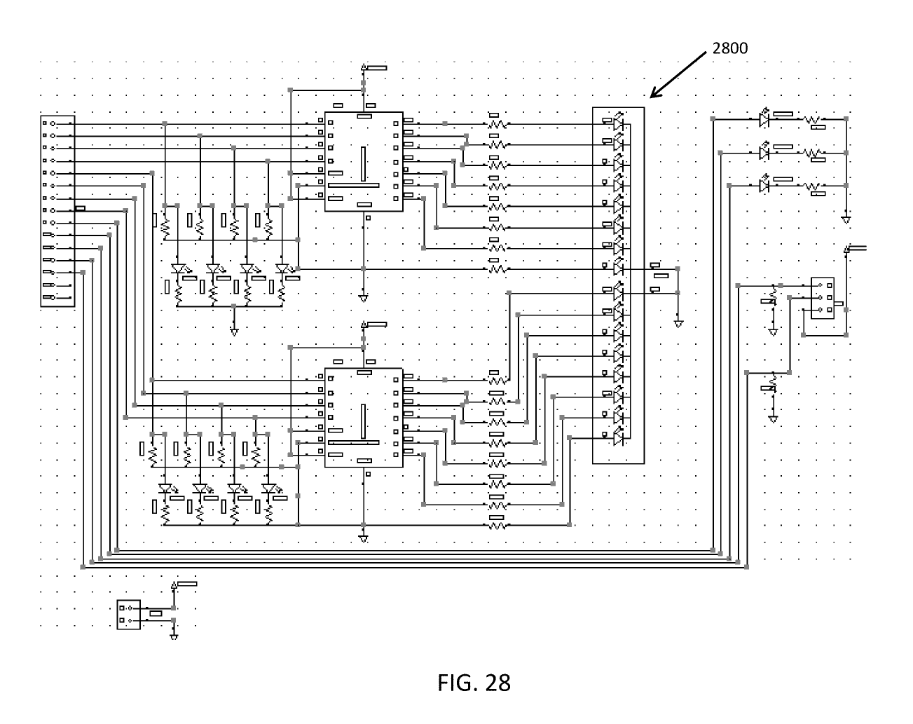

FIG. 26 illustrates a voltage selection module 2600 in accordance with some embodiments of the invention. In some embodiments, at least one portion of the voltage selection module 2600 can control voltage of the system. Further, FIG. 27 illustrates a circuit board layout 2700 in accordance with some embodiments of the invention.

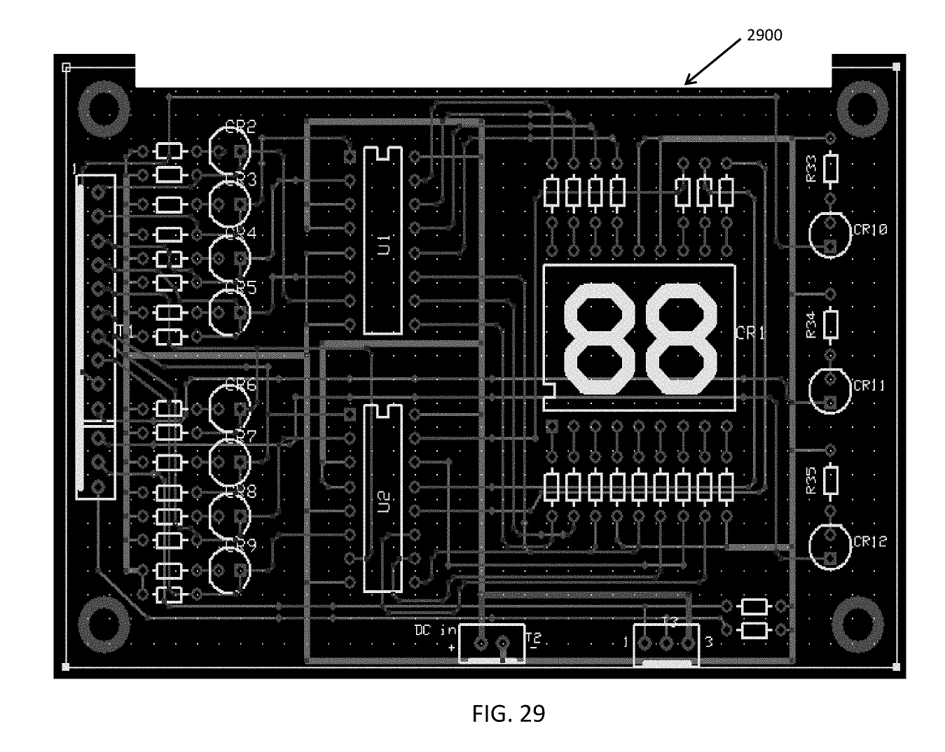

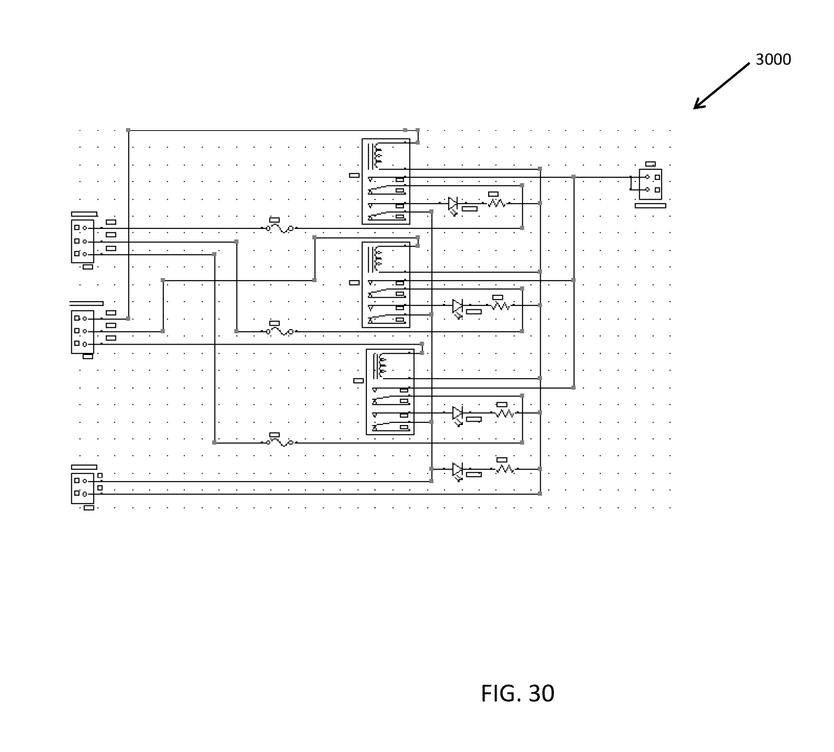

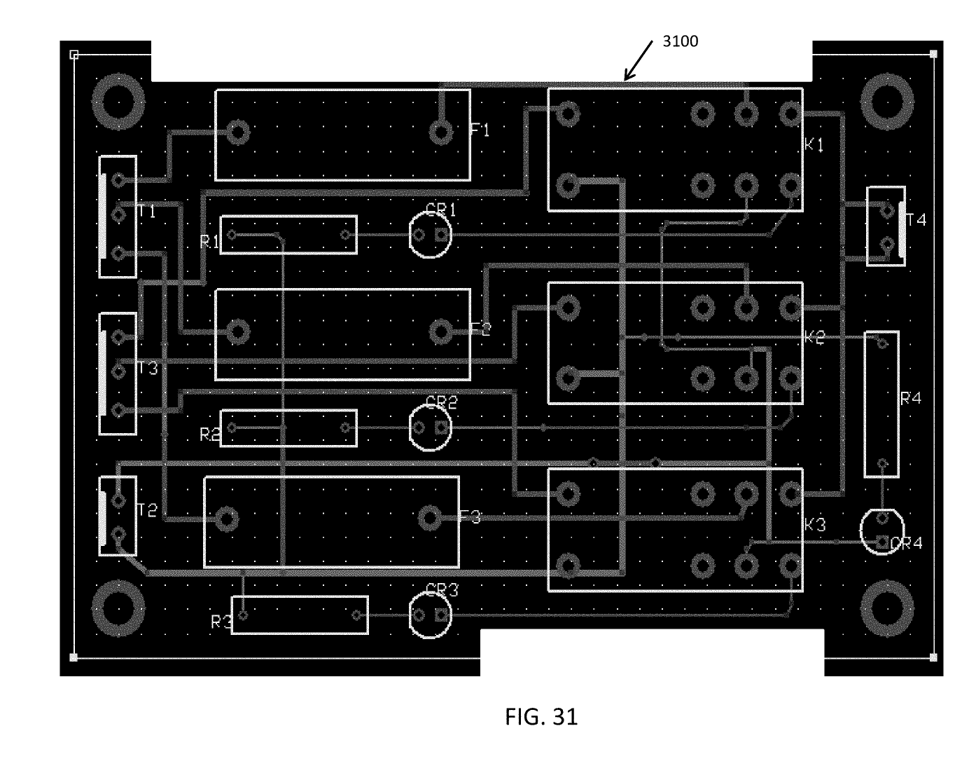

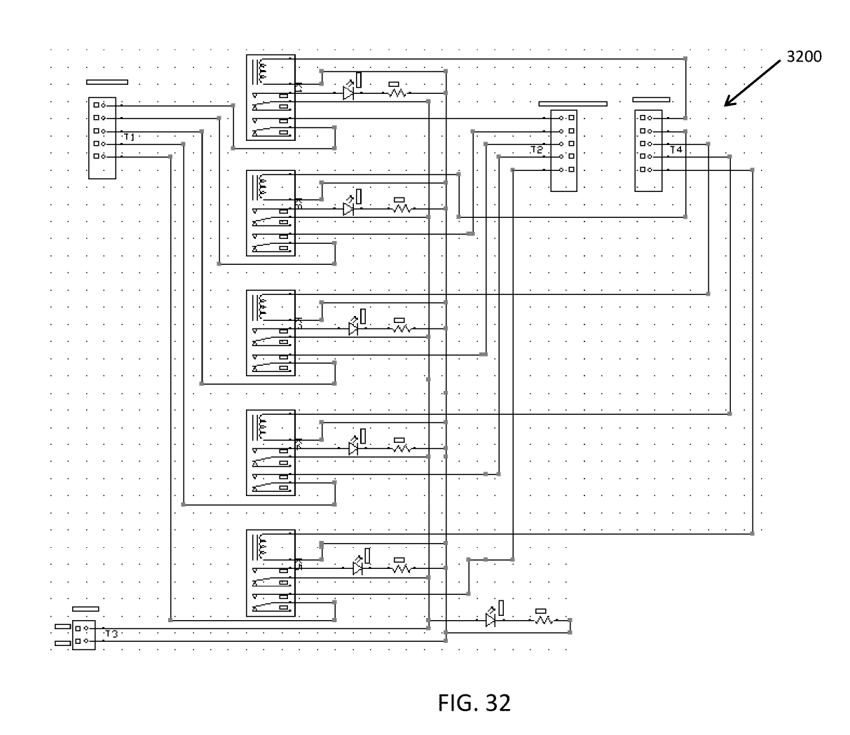

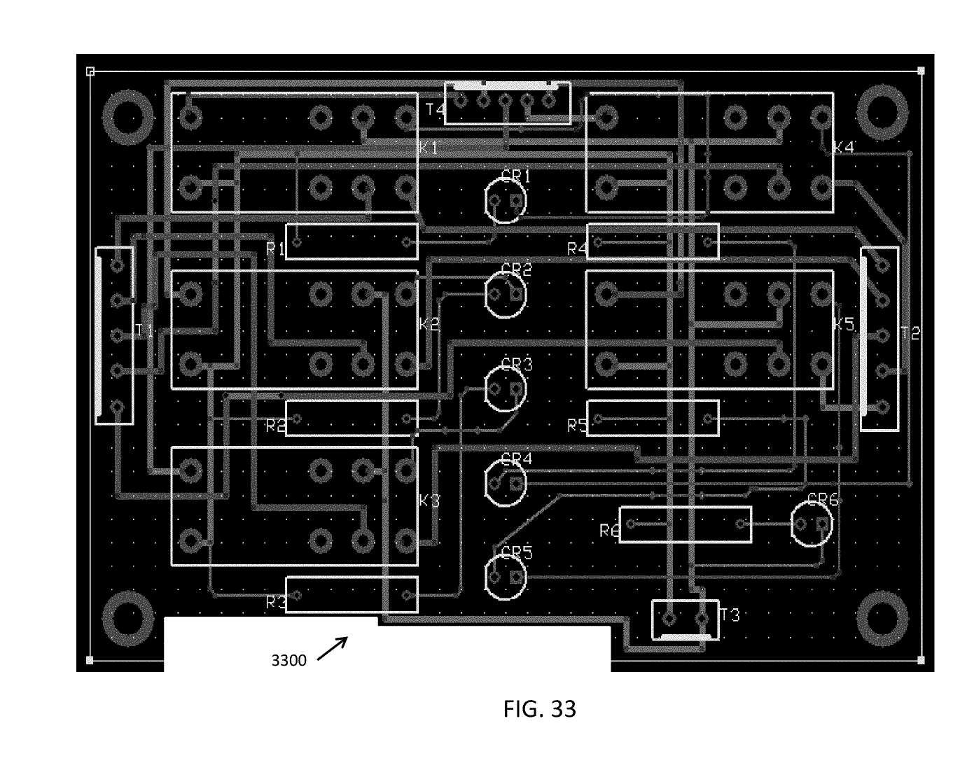

FIG. 28 illustrates a wiring diagram 2800 in accordance with some embodiments of the invention. FIG. 29 illustrates a circuit board layout 2900 in accordance with some embodiments of the invention. FIG. 30 illustrates a wiring diagram 3000 in accordance with some embodiments of the invention. FIG. 31 illustrates a circuit board layout 3100 in accordance with some embodiments of the invention. FIG. 32 illustrates a wiring diagram 3200 in accordance with some embodiments of the invention. FIG. 33 illustrates a circuit board layout 3300 in accordance with some embodiments of the invention. In some embodiments, at least one of the aforementioned systems or methods can comprise, utilize, and/or be enabled by one or more the voltage selection module 2600, circuit board layout 2700, wiring diagram 2800, circuit board layout 2900, wiring diagram 3000, circuit board layout 3100, wiring diagram 3200, and/or circuit board layout 3300. For example, in some embodiments, the voltage selection module 2600 and circuit board layout 2700 can comprise voltage selection module of the training and practical assessment system and method for metering personnel. Further, in some embodiments, the display/trainee interface module can comprise the wiring diagram 2800, circuit board layout 2900. Further, in some embodiments, the jaw module can comprise the wiring diagram 3000, circuit board layout 3100, and/or the child voltage module can comprise the wiring diagram 3200, and/or circuit board layout 3300.

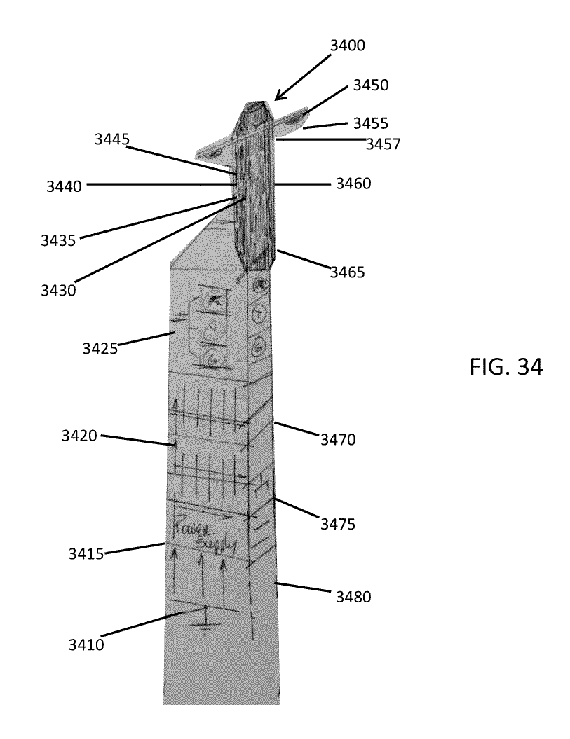

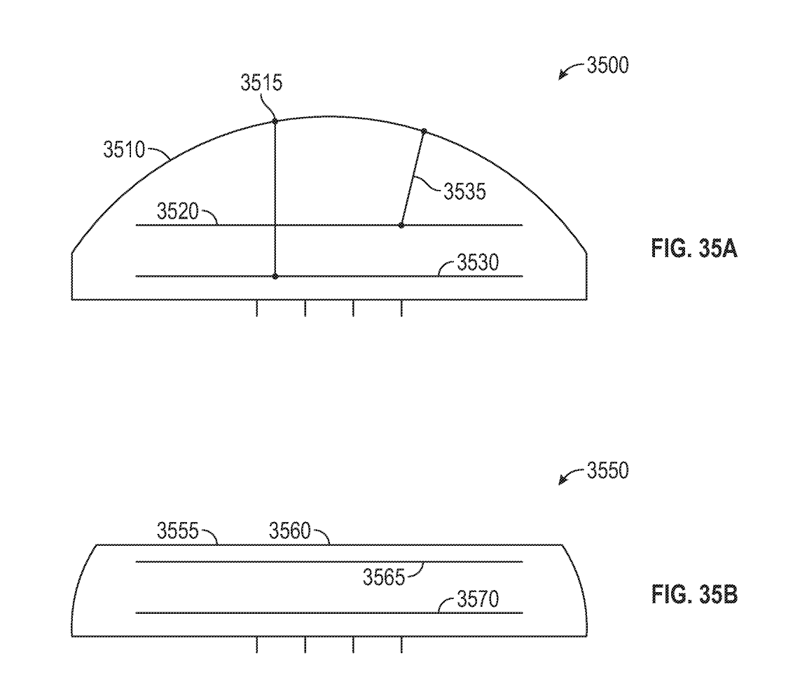

Some embodiments comprise the smart pole architecture 3400 shown FIG. 34. In accordance with some embodiments of the invention, the smart pole architecture 3400 can comprise a portion 3480 that is below ground as shown. In some embodiments, power cables 3410 can couple to the smart pole architecture 3400 coupling underground as shown. Further, some embodiments comprise a fiber optic entry 3415. Some embodiments can also include at least one electronic display 3420 (e.g., such as an electronic advertising board). In some embodiments, the smart pole architecture 3400 can comprise traffic controls 3425. In other embodiments of the invention, the smart pole architecture 3400 can comprise one or more communications include a sensor communication 3430, and/or a public safety communication 3435, and/or a context communication 3440, and/or a command and control communication 3445.

In some further embodiments of the invention, the smart pole architecture 3400 can comprise a street light 3450. Further, some embodiments include video monitoring capability (shown as 3455). In some other embodiments, the smart pole architecture 3400 can comprise environmental sensors 3457. Some further embodiments also include one or more communication systems such as an RF antenna capable of Wi-Fi, and/or 4G, and/or 5G, and/or 60 Hz (shown as 3460). Some embodiments include transmissions systems for information on one or more systems (shown as 3465).

FIGS. 35A-35B illustrate layouts of smart pole heads 3500 and 3550 respectively in accordance with some embodiments of the invention. Some embodiments include head 3500 comprising an antenna/AMI 3510 and/or a cable 3515, and/or a head 3520, and/or a cable 3535, and/or an NGM slot 3530. Further, other embodiments include head 3550 comprising antenna/AMI 3550, and/or antenna cellular 3560, and/or mic slot 3565, and/or NGM slot 3570.

FIG. 36 illustrates a computer system 99 suitable for operating and/or managing the processing, communication, and data transfer protocols of resource delivery and metering system such as meter 101 and/or any of the assemblies described herein. As shown, in some embodiments, a computer system 30 can include at least one computing device, including at least one or more processors 32. Some processors 32 can include processors 32 residing in one or more conventional server platforms. In some embodiments, the computer system 30 can include a network interface 35a and an application interface 35b coupled to at least one processor 32 capable of running at least one operating system 34. Further, in some embodiments, the computer system 30 can include a network interface 35a and an application interface 35b coupled to at least one processor 32 capable of running one or more of the software modules (e.g., such as one or more enterprise applications 38). In some embodiments, the software modules 38 can include server-based software platform that can include resource metering system and method software modules suitable for hosting at least one user account and at least one client account, as well as transferring data between one or more accounts.

Some embodiments of the invention also relate to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, in some embodiments, the operations can be processed by a general-purpose computer selectively activated or configured by one or more computer programs stored in the computer memory, cache, or obtained over a network. In some embodiments, when data are obtained over a network the data can be processed by other computers on the network, e.g. a cloud of computing resources.

With the above embodiments in mind, it should be understood that some embodiments of the invention can employ various computer-implemented operations involving resource and data/information metering systems, and method data stored in computer systems. Moreover, in some embodiments, the above-described databases and models throughout the resource metering system and method can store analytical models and other data on computer-readable storage media 36 within the computer system 30 and on computer-readable storage media 36 coupled to the computer system 30. In addition, in some embodiments, the above-described applications of the resource metering system and method can be stored on computer-readable storage media 36 within the computer system 30 and on computer-readable storage media 36 coupled to the computer system 30. These operations are those requiring physical manipulation of physical quantities. Usually, though not necessarily, these quantities can take the form of electrical, electromagnetic, or magnetic signals, optical or magneto-optical form capable of being stored, transferred, combined, compared and otherwise manipulated.

Some embodiments of the invention include a computer system 30 comprising at least one computer readable medium 36 coupled to at least one data storage device 37b, and/or at least one data source 37a, and/or at least one input/output device 37c. In some embodiments, the invention embodied by the resource metering system and method (e.g., meter 101 or other assembly coupled to or including meter 101) can be implemented as computer readable code on a computer readable medium 36. In some embodiments, the computer readable medium 36 can be any data storage device that can store data, which can thereafter be read by a computer system (such as the computer system 30). Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor (including by one or more processors 32).

In some embodiments of the invention, the computer readable medium 36 can also be distributed over a conventional computer network via the network interface 3 5a so that the resource metering system and method embodied by the computer readable code can be stored and executed in a distributed fashion. For example, in some embodiments, one or more components of the computer system 30 can be tethered to send and/or receive data through a local area network (“LAN”) 39a. In some further embodiments, one or more components of the computer system 30 can be tethered to send or receive data through an internet 39b (e.g., a wireless internet). In some embodiments, at least one software application 38 running on one or more processors 32 can be configured to be coupled for communication over a network 39a, 39b. In some embodiments, one or more components of the network 39a, 39b can include one or more resources for data storage, including any other form of computer readable media beyond the media 36 for storing information and including any form of computer readable media for communicating information from one electronic device to another electronic device.

In some embodiments, the network 39a, 39b can include wide area networks (“WAN”), direct connections (e.g., through a universal serial bus port) or other forms of computer-readable media 36, or any combination thereof. Further, in some embodiments, one or more components of the network 39a, 39b can include a number of client devices which can be personal computers 40 including for example desktop computers 40d, laptop computers 40a, 40e, digital assistants and/or personal digital assistants (shown as 40c), cellular phones or mobile phones or smart phones (shown as 40b), pagers, digital tablets, internet appliances, and other processor-based devices. In general, a client device can be any type of external or internal devices such as a mouse, a CD-ROM, DVD, a keyboard, a display, or other input or output devices 37c. In some embodiments, various other forms of computer-readable media 36 can transmit or carry instructions to one or more computers 40, including a router, private or public network, or other transmission device or channel, both wired and wireless. In some embodiments, the software modules 38 can be configured to send and receive data from a database (e.g., from a computer readable medium 36 including data sources 37a and data storage 37b that can comprise a database), and data can be received by the software modules 38 from at least one other source. In some embodiments, at least one of the software modules 38 can be configured within the system to output data to a user 31 via at least one digital display (e.g., to a computer 40 comprising a digital display).

In some embodiments, the computer system 30 as described can enable one or more users 31 to receive, analyze, input, modify, create and send data to and from the computer system 30, including to and from one or more enterprise applications 38 running on the computer system 30. Some embodiments include at least one user 31 coupled to a computer 40 accessing one or more modules of the resource metering system and method including at least one enterprise applications 38 via a stationary I/O device 37c through a LAN 39a. In some other embodiments, the computer system 30 can enable at least one user 31 (through computer 40) accessing enterprise applications 38 via a stationary or mobile I/O device 37c through an internet 39a.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

1. A resource metering system comprising;
at least one resource meter including one or more sensors;
at least one automatic shut-off valve;
at least one coupled power source;
a capacitor-based charging circuit;
at least one RF communications board; and
at least one processor executing instructions from a non-transitory computer-readable storage medium of a resource distribution system, the instructions configured to cause the at least one processor to:
wirelessly receive and act on one or more signals or data transmitted from the at least one RF communication board, the one or more signals or data being received from the one or more sensors.

2. The system of claim 1, wherein the at least one resource meter includes at least one integrated or coupled metrology board.

3. The system of claim 1, wherein the at least one resource meter includes at least one coupled AC power supply coupled to the capacitor-based charging circuit.

4. The system of claim 1, wherein the at least one resource meter includes at least one battery coupled to the capacitor-based charging circuit.

5. The system of claim 1, wherein the at least one coupled power source comprises a capacitor of the capacitor-based charging circuit.

6. The system of claim 1, wherein the one or more sensors comprises at least one of a flow sensor and a pressure sensor.

7. The system of claim 1, wherein the at least one sensor comprises at least one of a resource sensor and a temperature sensor

8. The system of claim 1, wherein the at least one sensor comprises a seismic sensor.

9. The system of claim 1, wherein the capacitor-based charging circuit comprises an output circuit including a chargeable capacitor coupled to a plurality of switches, wherein the state of the switches controls charging or discharging of the capacitor.

10. The system of claim 1, wherein the instructions are configured to cause a processor to operate the automatic shut-off valve based at least in part on a state or operation of the one or more sensors.

11. The system of claim 1, wherein the at least one coupled power source comprises a source of gas, and the at least one resource meter is a gas meter.

12. A computer-implemented method of metering a resource comprising:
at least one processor executing instructions from a non-transitory computer-readable storage medium of a resource distribution system, the instructions configured to cause a processor to:
wirelessly receive and act on one or more signals or data from one or more sensors of a resource delivery system; and
monitor and track resource usage and/or operations of the at least one at least one resource meter, the resource delivery system comprising:
at least one resource meter including the one or more sensors, and at least one automatic shut-off valve, a coupled power source, capacitor-based charging circuit, and at least one RF communications board.

13. The computer-implemented method of claim 12, wherein the at least one resource meter includes at least one integrated or coupled metrology board.

14. The computer-implemented method of claim 12, wherein the at least one resource meter includes at least one coupled AC power supply coupled to the capacitor-based charging circuit.

15. The computer-implemented method of claim 12, wherein the at least one resource meter includes at least one battery coupled to the capacitor-based charging circuit.

16. The computer-implemented method of claim 12, wherein the one or more sensors comprise at least one of a flow sensor and a pressure sensor.

17. The computer-implemented method of claim 12, wherein the one or more sensors comprise at least one of a resource sensor and a temperature sensor.

18. The computer-implemented method of claim 12, wherein the one or more sensors comprise a seismic sensor.

19. The computer-implemented method of claim 12, wherein the capacitor-based charging circuit comprises an output circuit including a chargeable capacitor coupled to a plurality of switches, wherein the state of the switches controls charging or discharging of the capacitor.

20. The computer-implemented method of claim 12, wherein the instructions are configured to cause a processor to operate the automatic shut-off valve based at least in part on a state or operation of the one or more sensors.
